(19) United States
(12) Patent Application Publication
(10) Pub. No.: US 2016/0094393 A1
(43) Pub. Date: Mar. 31, 2016

(54) MANAGEMENT APPARATUS, METHOD OF MANAGING A NETWORK AND STORAGE MEDIUM

(71) Applicant: Hitachi, Ltd., Tokyo (JP)

(72) Inventors: Kosuke KANEKO, Tokyo (JP); Yoji OZAWA, Tokyo (JP); Junji KINOSHITA, Tokyo (JP); Osamu TAKADA, Tokyo (JP); Yukio OGAWA, Tokyo (JP)

(21) Appl. No.: 14/859,561

(22) Filed: Sep. 21, 2015

(30) Foreign Application Priority Data
Sep. 25, 2014 (JP) 2014-195485

(51) Int. Cl. H04L 12/24; G06F 17/30

(52) U.S. Cl. CPC H04L 41/0869; H04L 41/0654; G06F 17/30371; G06F 17/30312

(57) ABSTRACT

A management apparatus that manages a network apparatus having a packet control function, wherein the network apparatus has configuration information that sets the control function, and wherein the management apparatus has: parameter information that manages settings of the control function of the network apparatus; and an inconsistent data detection module that obtains the configuration information from the network apparatus, and upon comparison of the configuration information with the parameter information, detects, as inconsistent data, information that does not match.

### CLAIM OF PRIORITY

The present application claims priority from Japanese patent application JP 2014-195485 filed on Sep. 25, 2014, the content of which is hereby incorporated by reference into this application.

### BACKGROUND

The present invention relates to a device that manages a network device, and a management method.

In recent years, the use of data centers as a foundation for cloud services and the like has developed. In order to perform services, data centers house a plurality of network devices such as middleboxes (hereinafter referred to as MBs) (defined in RFC 3234), such as firewalls for network security, such as load balancers that handle network bands by load distribution, and switching devices that relay communication. These network devices are necessary components for a cloud network, which provides a cloud service.

Cloud networks came to be managed by abstracting configurations and settings of network devices by the introduction of network management apparatuses referred to as software defined networking (SDN) foundations or the like, in order to improve ease and flexibility of management.

However, abstraction of configurations and settings results in inconsistency between setting data (hereinafter referred to as parameter information) for network devices managed by a managing device and the content of actual setting data (hereinafter referred to as configuration information) set for network devices, and this has resulted in problems. If, for example, setting data exists only for configuration information, then this data results in unexpected failures and decrease in performance of devices.

However, there is a problem that in order to detect inconsistency between parameter information and configuration information, the parameter information and configuration information, which have different data structures, must be compared. Furthermore, data centers and the like are deployed with a plurality of network devices, and thus, a large amount of data must be compared, and inconsistent data must be detected from among this information, which is difficult to do manually. Even if it were possible to detect inconsistencies manually, whether or not the data is consistent must be investigated, which requires a large number of man-hours or a large amount of labor.

The related art to solve these problems is being considered. For example, a technique of obtaining configuration information not used in a firewall and disclosing this to the user of a firewall is known (Algosec, Intelligent Policy Tuner, for example).

### SUMMARY

In the technique disclosed in Non-Patent Document 1, even if configuration information that is not in use were obtained, it is not possible to determine whether or not the configuration information exists in the parameter information of the management device. Furthermore, focusing only on the firewall presents that problem that it is not possible to determine whether unused configuration information affects the controlling of communications of other devices on the cloud network, and that it is not possible to determine whether the configuration information obtained as in the conventional example and the parameter information of the management device is correct or incorrect or whether or not the information is necessary.

In other words, it was difficult to detect inconsistent data from the parameter information and configuration information in the above conventional example. Also, in the conventional example, there was a problem that a large number of man-hours or a large amount of labor would be needed in determining whether the inconsistent parameter information and configuration information is correct or incorrect, or necessary or unnecessary.

The present invention takes into account the above-mentioned problems, and an object thereof is to detect inconsistency between parameter information of a management device and configuration information of a network device, and to reduce to the amount of labor required to determine whether the inconsistent parameter information and configuration information are correct or incorrect, or necessary or unnecessary.

A representative aspect of the present disclosure is as follows. A management apparatus that manages a network apparatus having a packet control function, wherein the network apparatus has configuration information that sets the control function, and wherein the management apparatus has: parameter information that manages settings of the control function of the network apparatus; and an inconsistent data detection module that obtains the configuration information from the network apparatus, and upon comparison of the configuration information with the parameter information, detects, as inconsistent data, information that does not match.

Thus, in the present invention, it is possible to determine with ease whether or not the parameter information of the network device managed by a managing device is inconsistent with the configuration information of the network device.

### BRIEF DESCRIPTION OF THE DRAWINGS

FIG. 1 is a block diagram showing on example of main parts of a computer system according to a first embodiment of this invention.

FIG. 2 is a block diagram that shows respective components of the computer system according to the first embodiment of this invention.

FIG. 3 is a block diagram showing one example of a configuration of the network management apparatus according to the first embodiment of this invention.

FIG. 4 shows an example of a configuration of the topology table according to the first embodiment of this invention.

FIG. 5 shows an example of the parameter table of the firewall according to the first embodiment of this invention.

FIG. 6 shows an example of the parameter table of the router according to the first embodiment of this invention.

FIG. 7 shows an example of the parameter table of the load balancer according to the first embodiment of this invention.

FIG. 8 shows an example of the inconsistent data table according to the first embodiment of this invention.

FIG. 9 shows an example of the index determination table according to the first embodiment of this invention.

FIG. 10 shows an example of the configuration and parameter conversion table according to the first embodiment of this invention.

FIG. 11 is a block diagram showing a configuration of a middlebox apparatus according to the first embodiment of this invention.

FIG. 12 is a block diagram showing a configuration of the server and the virtualization management apparatus according to the first embodiment of this invention.

FIG. 13 is a sequence diagram showing an example of a process performed by the computer system according to the first embodiment of this invention.

FIG. 14 is a flowchart showing an example of the process performed in the inconsistent data detection module according to the first embodiment of this invention.

FIG. 15 shows a screen image displayed in the output module according to the first embodiment of this invention.

FIG. 16 is an example of a screen image that displays inconsistent data content according to the first embodiment of this invention.

FIG. 17 shows a flowchart by which the inconsistent data handling determination module according to the first embodiment of this invention.

FIG. 18 is a flowchart in which the inconsistent data handling determination module according to the first embodiment of this invention.

FIG. 19 is a flowchart showing one example of an inconsistent data process performed by the inconsistent data handling determination module according to the first embodiment of this invention.

FIG. 20 is a flowchart showing an example of a process performed by the inconsistent data handling determination module for handling the new introduction of the network management apparatus according to a second embodiment of this invention.

### DETAILED DESCRIPTION OF EMBODIMENTS

Embodiments of the present invention will be described below with reference to affixed drawings.

### Embodiment 1

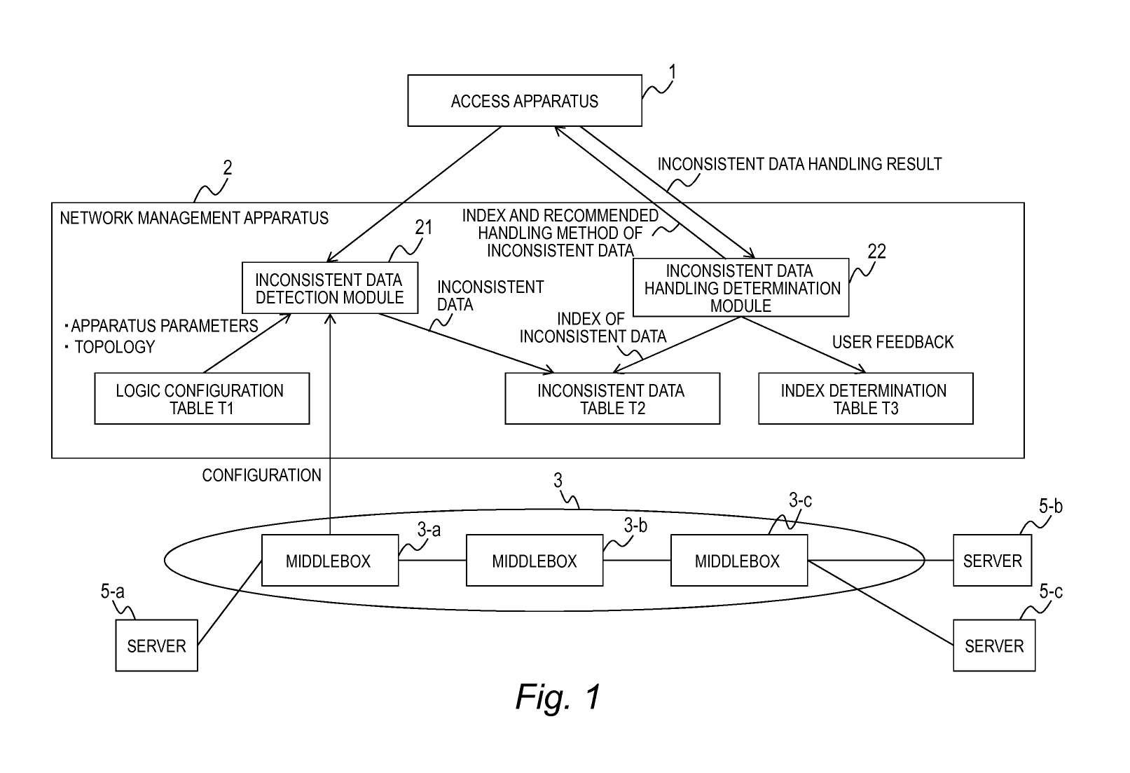

FIG. 1 shows Embodiment 1 of the present invention, and is a block diagram showing on example of main parts of a computer system that provides a service using a plurality of servers.

Embodiment 1 is a computer system in which middleboxes 3 (3-a, 3-b, 3-c), which realize intercommunication between servers 5 (5-a, 5-b, 5-c), are controlled by a network management apparatus 2. Below, the servers 5-a to 5-c are collectively assigned the reference character 5, and hyphenated reference characters are used when referring to individual devices. The same applies to the middleboxes 3 (hereinafter referred to as MBs) and other devices.

The network management apparatus 2 stores in a logic configuration table T1 a network topology of a computer system, or in other words, the arrangement and settings of the servers 5 and MBs 3, and parameter information, which is an abstraction of setting data of the MBs 3. With an inconsistent data detection module 21, the network management apparatus 2 gathers configuration information, which is data actually set to the MBs 3, compares the configuration information with parameter information, and detects non-matching data (hereinafter referred to as inconsistent data). The configuration information of the MBs 3 is setting information including definitions of functions of the MBs and packet control information. The configuration information of the MBs 3 can be set by the network management apparatus 2.

The network management apparatus 2 calculates an index indicating the plausibility of whether or not there is inconsistent data such that a user (or manager) of the computer system (sometimes referred to simply as the “user” below) can determine with ease whether or not the configuration information and parameter information included among the inconsistent data is correct, and whether or not the inconsistent data is needed. The index may determine the degree of plausibility of whether or not inconsistent data exists. Alternatively, the index may be determined as a value indicating whether or not it is correct that there is inconsistent data.

The network management apparatus 2 determines the recommended method to handle the inconsistent data on the basis of the index and transmits the recommended method to handle the data to an access apparatus 1 operated by the user.

The network management apparatus 2 calculates the index while referring to an index determination table T3, which defines the method of computing the index, in order to determine the recommended method to handle the data. An inconsistent data handling determination module 22 of the network management apparatus 2 executes log comparison of the MBs 3, comparison with the logic configuration table T1, and the like on the basis of data of the index determination table T3, and determines the recommended method to handle the data on the basis of the calculated index. The MBs 3 can generate action logs (or operation logs) corresponding to process execution results and event logs corresponding to setting modifications and the like and store them. Below, information including the action logs and event logs is referred to as logs. The network management apparatus 2 can gather logs of the MBs 3.

The network management apparatus 2 receives determination results for handling data selected by the user from the access apparatus 1. As will be described later, the network management apparatus 2 feeds back the received data handling determination results to the index for every determination method stored in the index determination table T3, thereby improving the accuracy of index calculation.

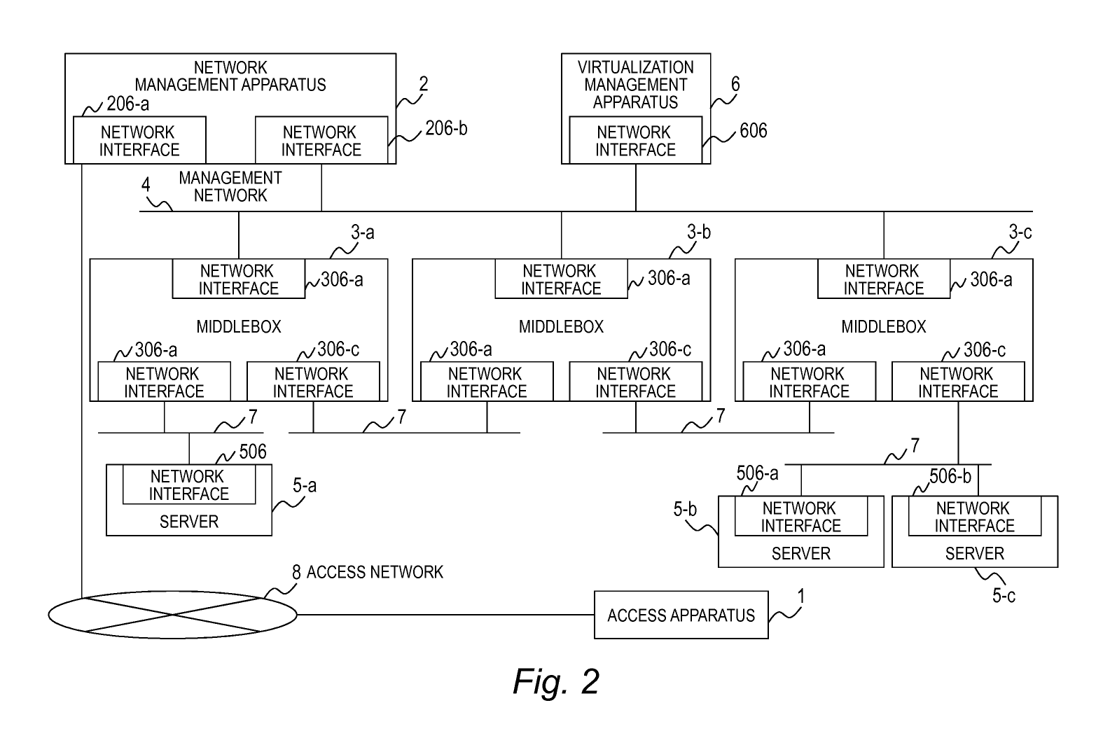

FIG. 2 is a block diagram that shows respective components of the computer system of Embodiment 1. The access apparatus 1 is coupled to the network management apparatus 2 through an access network 8. The access network 8 may be a network such as the internet or a WAN, for example. Also, the access apparatus 1 may be coupled to the managing network 4.

The user (or manager) of the computer system sends a request through the access apparatus 1 to the network management apparatus 2 to detect inconsistent data, and receives results of inconsistent data detection from the network management apparatus 2.

The network management apparatus 2, the MBs 3, and a virtualization management apparatus 6 including functions for managing virtual machines are coupled to a managing network 4 that sends communication traffic for controlling links between these devices.

The MBs 3 are coupled to a network 7 in order to relay communication traffic (packets) from the servers 5.

Communication traffic from the servers 5 is comprised of packets for the servers 5-a, 5-b, and 5-c to control each other, and if the server 5-a is a web server and the servers 5-b and 5-c are database servers, for example, then the communication traffic contains transmitted and received packets for the web server to control the database servers.

Below, for ease of understanding, the types of MBs 3 will be specifically described as follows: 3-a as the firewall (sometimes abbreviated as FW), 3-b as the router (sometimes abbreviated as RT), and 3-c as the load balancer (sometimes abbreviated as LB). The MBs 3 function as desired network devices corresponding to configuration information settings. The configuration information includes setting information for control functions of the MBs 3.

The servers 5 are all coupled to the network 7. The respective devices are coupled to the respective networks 4, 7, and 8 through network interfaces 206-a to 606.

The MBs 3 and the servers 5 may be virtual or physical devices. If they are virtual devices, then virtual servers and virtual MBs as virtual devices can be operated on physical computers on the basis of commands from the virtualization management apparatus 6.

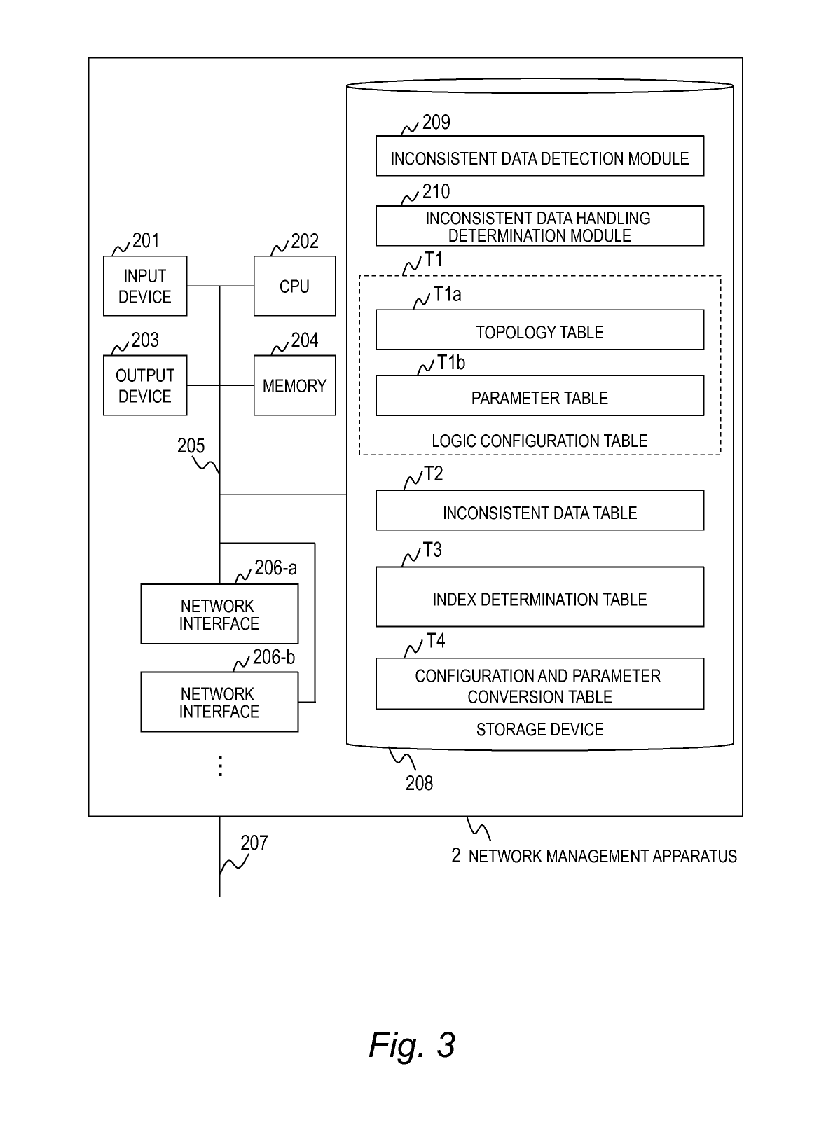

FIG. 3 is a block diagram showing one example of a configuration of the network management apparatus 2. The network management apparatus 2 of the present embodiment has a provisioning function and topology detecting function for the MBs 3. A publicly known or well-known technique may be used for the provisioning function and topology detecting function. For the provisioning function, it is possible to use JP 2013-97394 A (paragraphs [0115]-[0155], FIGS. 22-30), for example. For the topology detecting function, it is possible to use JP 2013-81053 A (paragraphs [0037]-[0138], FIGS. 2-14), for example.

The network management apparatus 2 has: an input module 201 that couples with input devices such as keyboards and mice; a CPU 202 (central processing unit) that executes various programs stored in a storage device 208; an output module 203 that outputs the execution results from the CPU 202 to devices such as monitors; a memory 204 in which intermediate results of execution and the like are stored; the storage device 208 that stores the network interfaces 206-a and 206-b coupled to a line 207 coupled to the network, various functional units, and various tables; and a data bus 205 coupling the above components. A plurality of each of the components may be provided.

The inconsistent data detection module 209 and the inconsistent data handling determination module 210 are loaded in the memory 204 as programs.

The CPU 202 operates as a functional unit that provides prescribed functions by executing processes according to programs in respective functional units. The CPU 202 functions as the inconsistent data detection module 209 by performing processes according to an inconsistent data detection program, for example. The same applies for other programs. Additionally, the CPU 202 also operates as functional units providing, respectively, functions of a plurality of processes executed by respective programs. The computer and the computer system are a device and system including these functional units.

Programs, data, tables, and the like realizing respective functions of the network management apparatus 2 can be stored in a storage device such as the storage device 208, a non-volatile semiconductor memory, a hard disk drive, or a solid state drive (SSD), or in a computer-readable non-transitory data storage medium such as an IC card, an SD card, or a DVD.

The storage device 208 stores various programs such as the inconsistent data detection module 209 and the inconsistent data handling determination module 210, and various tables such as a logic configuration table T1 including a topology table T1a and a parameter table T1b, an inconsistent data table T2, an index determination table T3, and a configuration and parameter conversion table T4.

The topology table T1a and the parameter table T1b are sometimes collectively referred to as the logic configuration table T1. The various programs and tables may be stored in the memory 304 or may be stored outside of the network management apparatus 2 if it can be accessed by the network management apparatus 2.

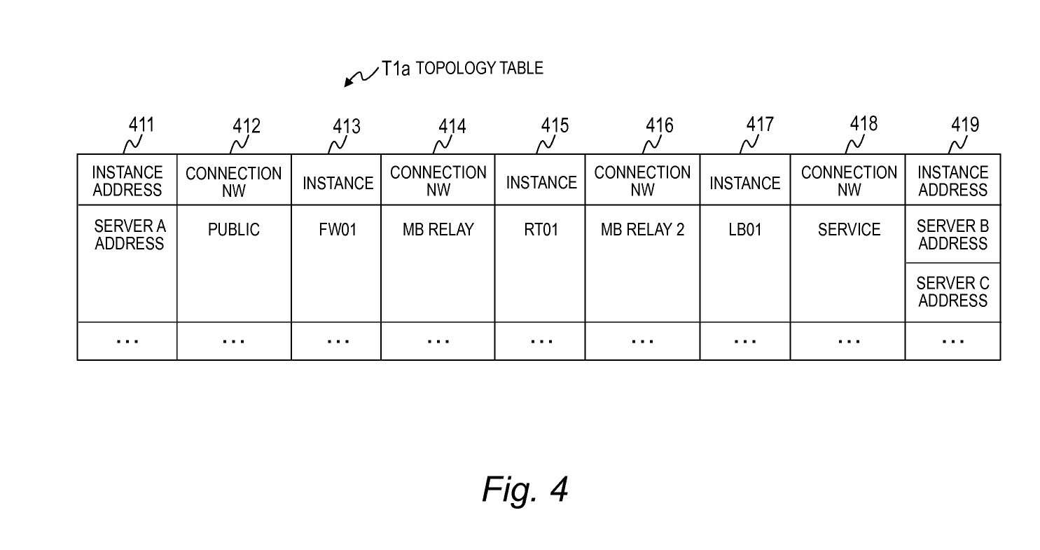

The respective tables will be explained below. FIG. 4 shows an example of a configuration of the topology table T1a. The topology table T1a stores connective relations between the servers 5 and the MBs 3. The topology table T1a includes in one record the following: an instance address field 411 storing the address of a device at the starting point of the connective relation; an instance address field 419 storing the address of the device at the end point of the connective relation; instance fields 413, 415, and 417 connecting the starting point instance address field 411 and the end point instance address field 419; and connective network (NW) fields 412, 414, 416, and 418 storing identifiers of networks connecting the instances.

The instance address fields 411 and 419 store IP (internet protocol) addresses. Alternatively, information that can uniquely identify instances such as fully qualified domain names (FQDN) may be stored. The instance fields 413 to 417 store identifiers of instances (numbers and names, for example). Instances are MBs 3 that are set up so as to be usable. Identifiers represent types of MBs 3 such as firewalls, routers, load balancers, NATs, and the like. The connective network fields 412 to 418 store identifiers of networks to which instances are connected. In the drawing, “public,” “MB relay,” “MB relay 2,” and “service” are identifiers of the respective networks 7 in FIG. 2. In the connection of the server 5-a to the servers 5-b and 5-c, the server 5-a is coupled to the servers 5-b and 5-c through the MB 3-a functioning as a firewall (FW01), the MB 3-b functioning as a router (RT01), and the MB 3-c functioning as the load balancer (LB01).

The topology table T1a may be generated by the network management apparatus 2 through the topology detection function or updated to the latest topology. Also, the number of connected NW fields and instance fields changes corresponding to the number of instances between the instance address fields 411 and 419.

The parameter table T1b differs in configuration for each instance type. In the present embodiment, an example is shown in which the parameter table T1b includes the firewall parameter table T1b-a, the router parameter table T1b-b, and the load balancer parameter table T1b-c.

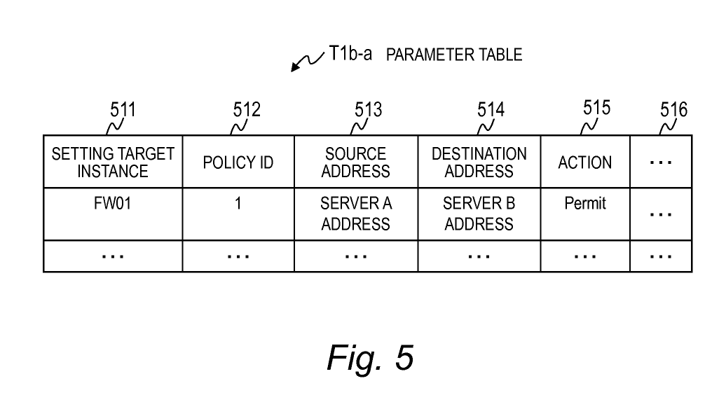

FIG. 5 shows an example of the parameter table T1b-a of the firewall instance. The parameter table T1b-a stores packet filtering policies.

The parameter table T1b-a includes as one record a setting target instance field 511, a policy ID field 512, a source address field 513, a destination address field 514, and an action field 515.

The setting target instance field 511 stores identifiers of instances for which filtering policies are to be set. The policy ID field 512 stores policy identifiers. The source address field 513 stores the address of the source device on which filtering is to be performed or the network address. The destination address field 514 stores the address of the destination device on which filtering is to be performed or the network address. The action field 515 stores “permitted” or “denied” to indicate whether or not packet transmission is permitted.

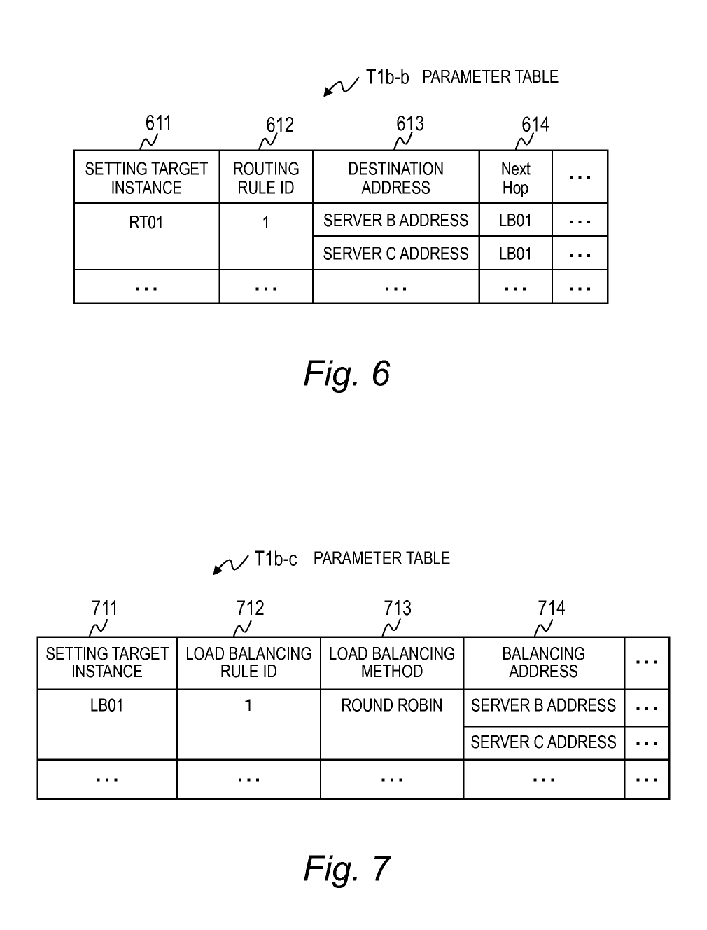

FIG. 6 shows an example of the parameter table T1b-b of the router instance. The parameter table T1b-b stores routing rules.

The parameter table T1b-b includes as one record a setting target instance field 611, a routing rule ID field 612, a destination address 613, and a next hop field 614.

The setting target instance field 611 stores identifiers of router instances for which routing rules are set. The routing rule ID field 612 stores routing rule identifiers. The destination address field 613 stores the destination address of the device to be routed or the network address. The next hop field 614 stores an address or interface to be routed.

FIG. 7 shows an example of the parameter table T1b-c of the load balancer instance. The parameter table T1b-c stores load balancing rules.

The parameter table T1b-c includes as one record a setting target instance field 711, a load balancing rule ID field 712, a load balancing method field 713, and a balancing address field 714.

The setting target instance field 711 stores identifiers of instances for which load balancing rules are set. The load balancing rule ID field 712 stores load balancing rule identifiers. The load balancing method field 713 stores a load balancing method such as round robin. The balancing field 714 stores the address or identifier of the instance to which packets are to be sent as a result of load balancing.

The respective parameter tables T1b-a to T1b-c may be generated by the network management apparatus 2 when provisioning the MBs 3 and updated to the latest parameters when modifying settings. Also, parameter tables for instances such as NAT other than the firewall, router, and load balancer may similarly be present.

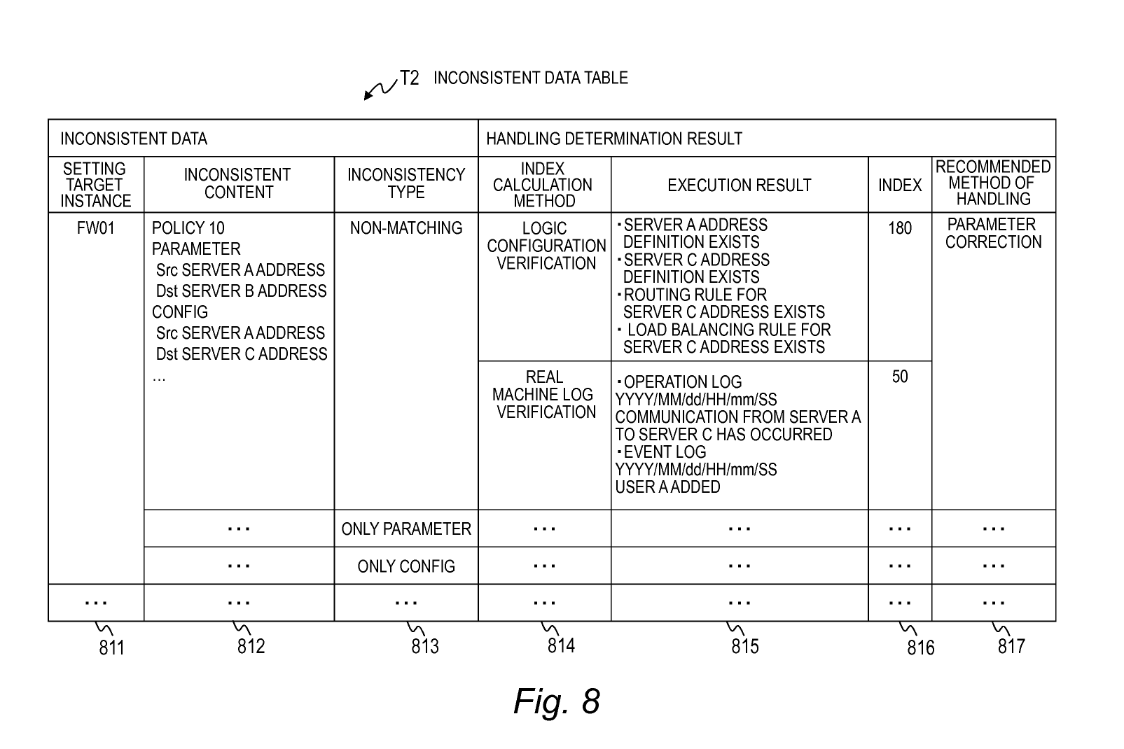

FIG. 8 shows an example of the inconsistent data table T2. The inconsistent data table T2 stores an index for each piece of inconsistent data detected by the network management apparatus 2 and recommendations on how to handle the inconsistent data.

The network management apparatus 2 outputs the inconsistent data table T2 to the user of the access apparatus 1, thereby allowing the user to verify the correctness and necessity of the configuration information and parameter information deemed to be inconsistent.

The inconsistent data table T2 includes in one record a setting target instance field 811, an inconsistent content field 812, an inconsistent type field 813, an index calculation method field 814, a method execution result field 815, an index field 816, and a recommended handling field 817. The inconsistent data table T2 has two types of fields: the setting target instance field 811 to the inconsistency type field 813 are included among inconsistent data, and the index calculation method field 814 to the recommended handling field 817 are included among handling determination results.

The setting target instance field 811 stores identifiers of instances for which inconsistent data is set. The inconsistent content field 812 stores data in which the parameter information and the configuration information are found to be inconsistent as a result of the network management apparatus 2 comparing the parameter information and the configuration information.

The inconsistency type field 813 only has configuration information, only has parameters, or stores inconsistent data types where values of the configuration information and parameter information are inconsistent.

The index calculation method field 814 stores a method (or process) executed to calculate the index. The execution result field 815 stores detailed results of executing the process of the index calculation method field 814. The index field 816 stores the index calculated by the network management apparatus 2. The recommended handling field 817 stores recommendations on how to handle inconsistent data such as add, delete, or correct (correcting parameter information or configuration information).

The index calculation method field 814 stores methods for calculating the preset index and includes logic configuration verification and real machine log verification. In logic configuration verification, the parameter information of the network management apparatus 2 and the configuration information of the inconsistent content field 812 of the setting target instance field 811 are verified with reference to the logic configuration table T1.

In real machine log verification, the parameter information of the network management apparatus 2 and the configuration information of the inconsistent content field 812 of the setting target instance field 811 are verified with reference to logs collected by the network management apparatus 2. Such verification processes will be described later.

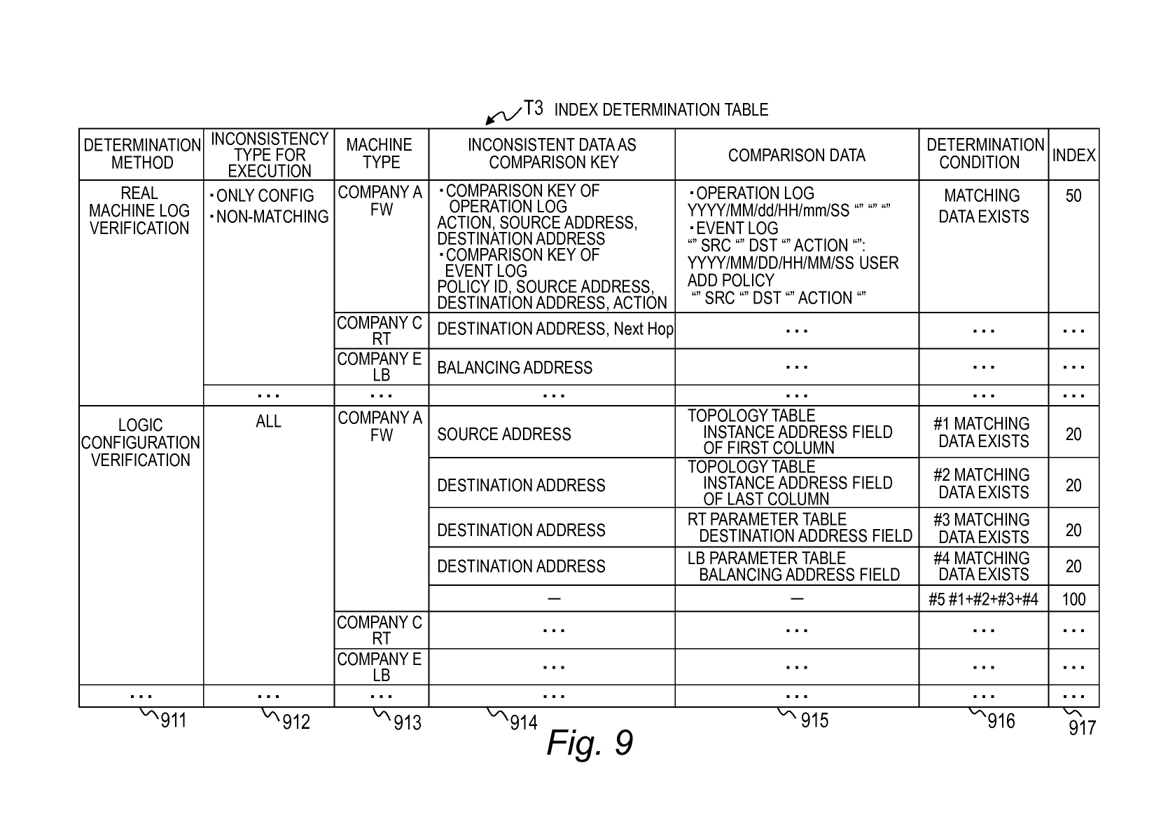

FIG. 9 shows an example of the index determination table T3. The index determination table T3 stores a method or process executed for calculating the index of the inconsistent data and an index for each determination method. The determination method for calculating the index of the inconsistent data can be performed by a publicly known or well-known means. It is possible to calculate the index by network simulation or with reference to logs of each device or the logic configuration table T1, for example. The size of the index differs depending on the method, and the degree of certainty thereof depends greatly on the knowledge of the user.

In the present embodiment, an example is shown in which a preset index field 917 is stored in the index determination table T3 corresponding to a determination method field 911 and a determination condition field 916. This index can be set by the user and can be set to the index field 917, which reflects the knowledge of the user.

If the index value is high, then this indicates that there is a high possibility that the presence of inconsistent data is correct. On the other hand, if the index value is low, then this indicates that there is a high possibility that the presence of inconsistent data is incorrect.

If logic configuration verification is set for the determination method field 911 then the network management apparatus 2 compares the inconsistent data to the logic configuration table T1, and if it is found that the inconsistent data is included in the logic configuration table T1, then the index is set high, and if it is found that inconsistent data is not included, then the index is set to be low, for example.

If real machine log verification is set for the determination method field 911, then if communication corresponding to the inconsistent data is stored in the log as a result of verifying the log of each device, the network management apparatus 2 sets the index high, but lower than if a plurality of pieces of inconsistent data are included in the logic configuration table T1 as a result of logic configuration verification.

On the other hand, if the communication is not recorded as a result of log verification, then the index is set low, but higher than if the inconsistent data is not included in the logic configuration table T1 as a result of logic configuration verification. The network management apparatus 2 calculates the index by a method such as that described above.

The index determination table T3 defines an index field 917 for each verification process set in the determination method field 911 and conditions (determination condition field 916) for setting the index field 917. The index determination table T3 includes in one record the determination method field 911, an inconsistency type for execution field 912, a machine type field 913, an inconsistent data field 914 as a comparison key, a comparison data field 915, a determination condition field 916, and an index field 917. The value of each field in the index determination table T3 may be inputted or transmitted from the access apparatus 1, for example.

The determination method field 911 stores a method (or process) executed to calculate the index of the inconsistent data. The inconsistency type for execution field 912 stores inconsistent data types (or patterns) such as only the configuration information, only the parameter information or both types of data being inconsistent, or in other words, whether inconsistent data is present only in one of the parameter information and the configuration information or whether inconsistent data is present in both the parameter information and the configuration information.

The machine type field 913 stores an identifier of the machine type of the instance in which the network management apparatus 2 detected inconsistent data. The inconsistent data field 914, which is the comparison key, stores one or more parameter items such as action, source address, and destination address.

The comparison data field 915 stores data to be compared of the inconsistent data field 914, which is the comparison key. The determination condition field 916 stores a condition of whether or not an index is assigned after the determination method field 911 is executed. The content of the determination method field 911 is executed and an index indicating that the result thereof matches the determination condition field 916 is stored in the index field 917.

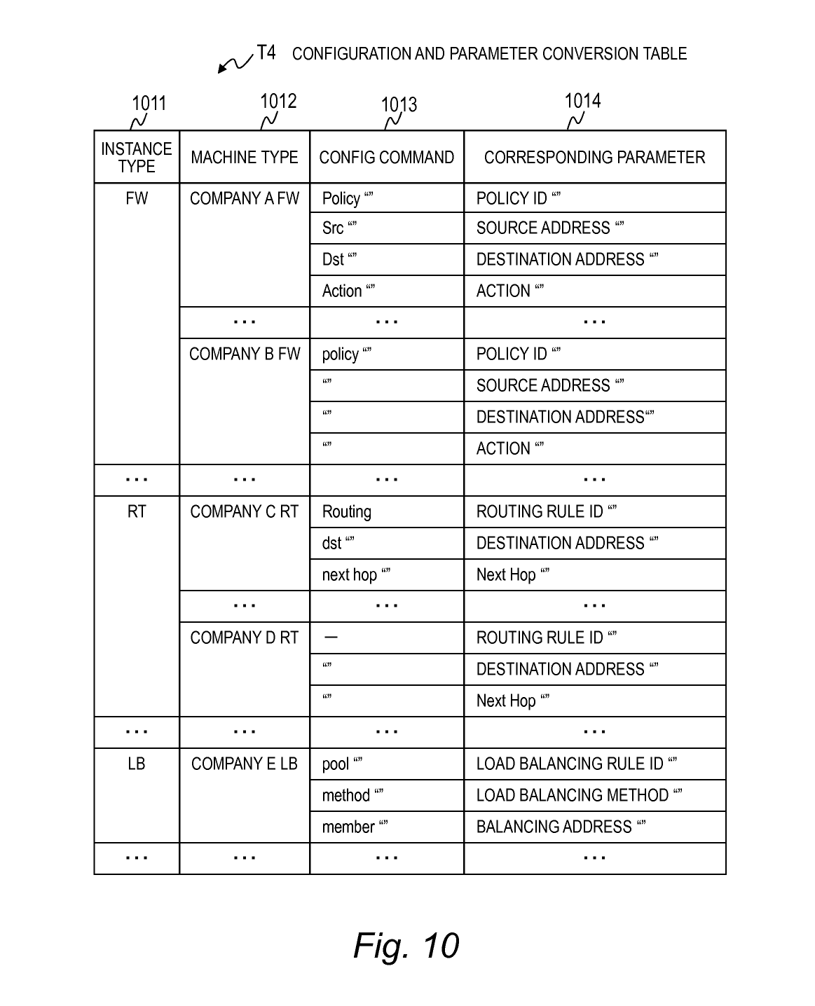

FIG. 10 shows an example of the configuration/parameter conversion table T4. The configuration and parameter conversion table T4 is used in order to convert configuration information obtained from the MBs 3 by the network management apparatus 2 into a parameter table structure. Alternatively, the configuration and parameter conversion table T4 may be used for conversion in the opposite direction, or in other words, conversion of the parameter table structure into the configuration information structure.

In order to do so, the configuration and parameter conversion table T4 includes an instance type field 1011, a machine type field 112, a config (configuration) command field 1013, and a correspondence parameter field 1014.

The instance type field 1011 stores an identifier representing the type of instance. The machine type field 1012 stores an identifier representing the machine type of the instance. The config command field 1013 stores a machine type-dependent command expression. The correspondence parameter field 1014 stores item of the parameter table T1b having the same meaning as the machine type-dependent config command expression, which is stored in the config command field 1013.

The config command field 1013 and the correspondence parameter field 1014 for each machine type field 1012 is information preset by a user or the like.

The components of the network management apparatus 2 have been described above. Next, devices other than the network management apparatus 2 will be described.

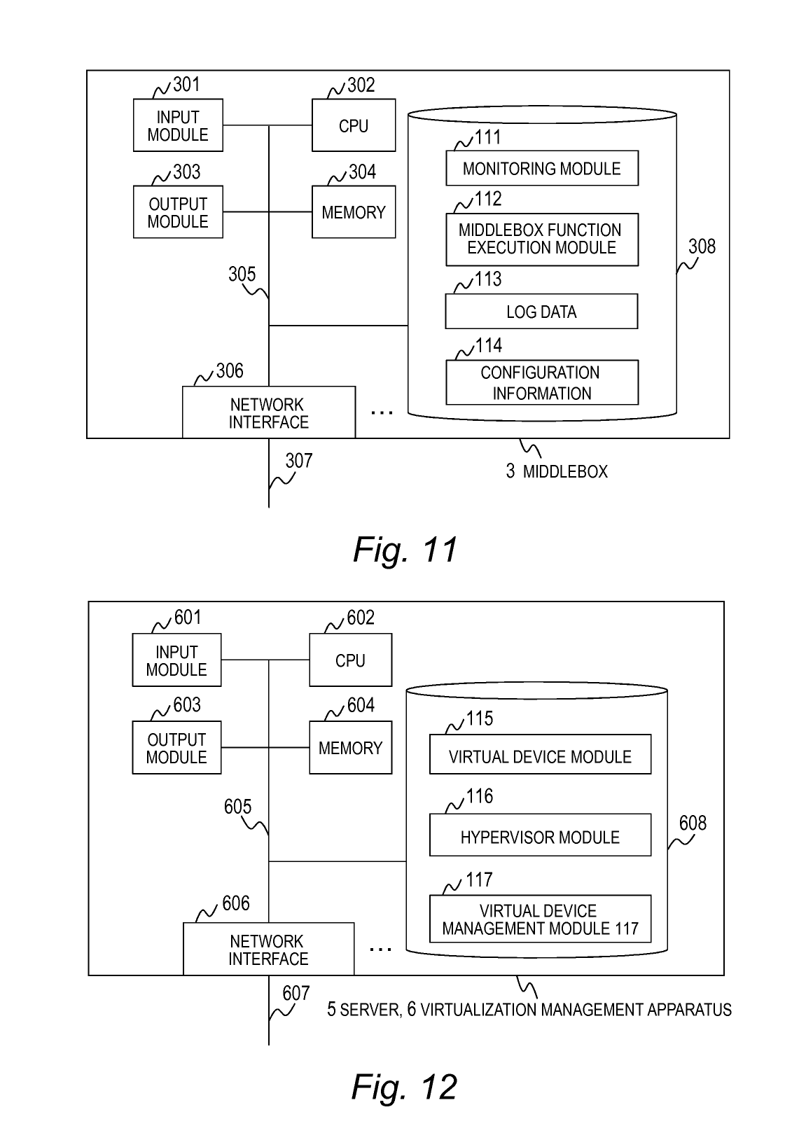

FIG. 11 is a block diagram showing a configuration of an MB 3. The MB 3 includes an input module 301, a CPU 302, an output module 303, a memory 304, a data bus 305, a network interface 306, and a line 307. These components are similar to those of the network management apparatus 2 shown in FIG. 3, but the programs and data stored in the storage device 308 differ. The storage device 308 stores a monitoring module 111, an MB function execution module 112, log data 113, and configuration information 114.

The monitoring module 111 has a function of storing the log data 113 of the MB function executed by the MB function execution module 112, and a function of transmitting the log data 113 to the network management apparatus 2. The MB function execution module 112 reads in the configuration information 114 and provides functions for each type of MB 3 such as filtering by a firewall, load balancing by a load balancer, and routing by a router. The functions of each type of MB 3 can be partially provided. The configuration information 114 is a table in which setting data for the MB function execution module 112 to provide MB functions is stored.

FIG. 12 shows the internal configuration of the server 5 and the virtualization management apparatus 6. The server 5 and the virtualization management apparatus 6 stores a virtual device module 115, a hypervisor 116, and a virtual machine management module 117 in the storage device 608.

The virtual device management module 117 is a function for realizing a virtual machine and a virtual MB device is realized by this function, for example. The hypervisor 116 links with the virtual device management module 117 and has the function of executing or deleting a virtual machine, executing or deleting a virtual switch, or the like.

The virtual device management module 117 receives necessary conditions for such linking from another device through the network interface 606, and has the function of outputting commands to the hypervisor module 116, and the like. Other components are similar to those of the network management apparatus 2 and the MBs 3.

The access apparatus 1 is also configured in a manner similar to the network management apparatus 2 and the MBs 3 other than the contents of the storage device 608. The access apparatus 1 includes a function of transmitting necessary conditions to respective programs to be stored by the network management apparatus 2 in the storage device 208. The access apparatus 1 has the function of transmitting commands and requests inputted by the user of the access apparatus 1 to an interface function that executes each program such as a CLI (command line interface), a GUI (graphical user interface), and an API (application programming interface).

The components of the computer system of Embodiment 1 are as described above. Below, the sequence of the processes of the access apparatus 1, the network management apparatus 2, and the MBs 3 will be described, and then the processes of the respective programs included in the network management apparatus 2 will be described.

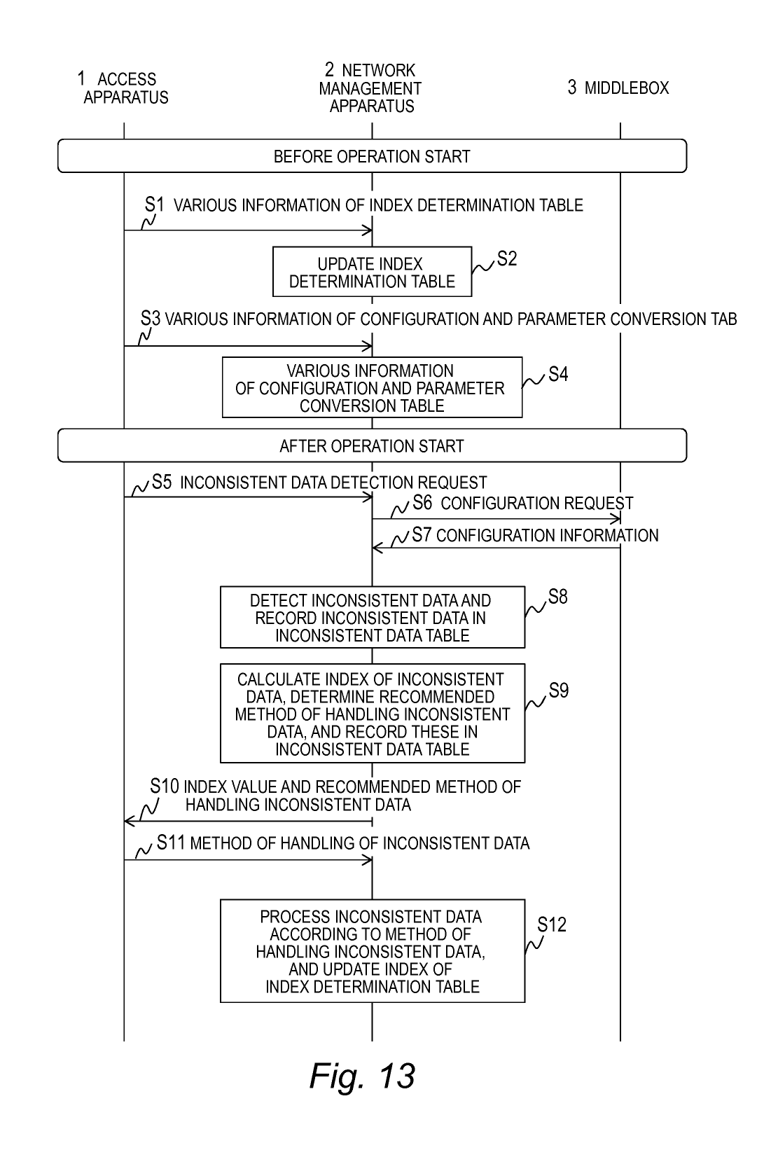

FIG. 13 is a sequence diagram showing an example of a process performed by the computer system. The sequences prior to and after operation of the computer system has started will each be described.

Prior to Operation Start

In step S1, the access apparatus 1 receives input from a user of the respective pieces of field information of the index determination table T3. The access apparatus 1 transmits the respective pieces of field information to the network management apparatus 2.

In step S2, the network management apparatus 2 records the value of each piece of field information received in step S1 to the index determination table T3.

In step S3, the access apparatus 1 receives input from a user of the respective pieces of field information of the configuration and parameter conversion table. The access apparatus 1 transmits the respective pieces of field information to the network management apparatus 2.

In step S4, the network management apparatus 2 records values received in step S3 to the respective type fields of the configuration and parameter conversion table T4.

Steps S1 to S4 above can also be executed at a desired timing after the operation has started in order to add definitions for new devices or new determination methods, to adjust the preset indices, or the like.

After Operation Start

In step S5, the access apparatus 1 transmits an inconsistent data detection request to the network management apparatus 2 on the basis of a command by the user.

In step S6, the network management apparatus 2 sends a transmission request for the configuration information 114 and the log data 113 to the MBs 3.

In step S7, the network management apparatus 2 receives the configuration information 114 and the log data 113 from the MBs 3.

In step S8, the network management apparatus 2 detects inconsistent data by comparing the parameter information and the configuration information 114 and records this to the inconsistent data table T2.

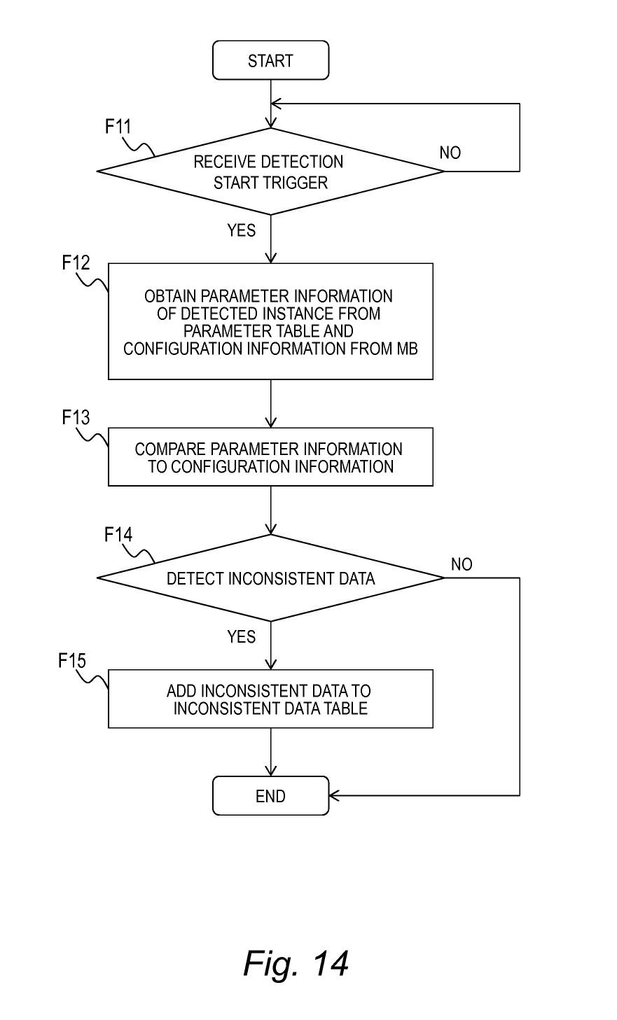

Details of the processes of steps S5 to S8 will be described later with reference to FIG. 14.

Next, in step S9, the network management apparatus 2 calculates the index of the inconsistent data detected in step S8, determines the recommended method of handling this inconsistent data on the basis of the calculated index, and updates the inconsistent data table T2.

In step S10, the network management apparatus 2 sends to the access apparatus 1 the detection results for the inconsistent data, or in other words, the inconsistent data, the inconsistent data type, the index, and the recommended method for handling the inconsistent data.

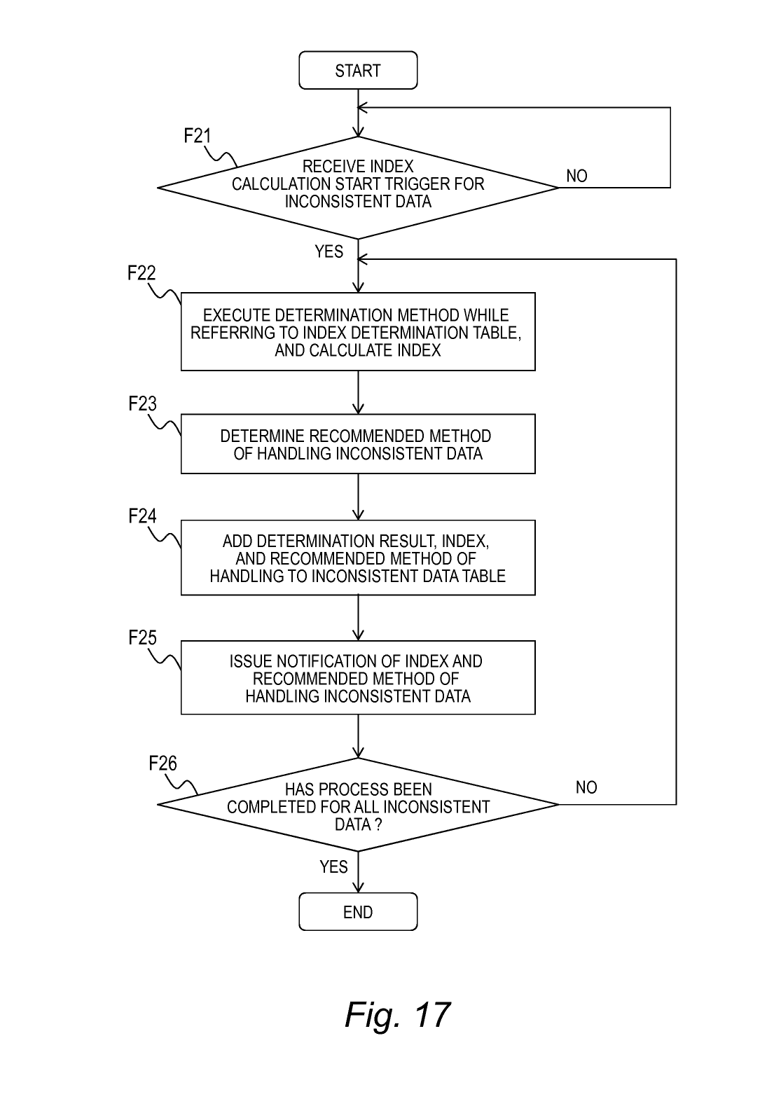

Details of the processes of steps S9 and S10 will be described later with reference to FIG. 17.

In step S11, the access apparatus 1 receives the method for handling the inconsistent data. The user of the access apparatus 1 decides how to actually handle the inconsistent data such as addition, correction, or deletion of the data while referring to the recommended method for handling the inconsistent data, and then inputs this decision to the access apparatus 1. The access apparatus 1 transmits the received method for handling the inconsistent data to the network management apparatus 2.

In step S12, the network management apparatus 2 receives the handling results for the inconsistent data inputted by the user to the access apparatus 1 in step S11. In the network management apparatus 2, processes such as addition, correction, or deletion of the inconsistent data are performed as decided by the user, and in addition, the indices in the index determination table T3 are updated corresponding to the decided handling results for the inconsistent data. The updating of the indices of the index determination table T3 is performed such that of the plurality of determination condition fields 916 set in the index determination table T3, the index field 917 is updated as feedback to the actually established determination condition field 916.

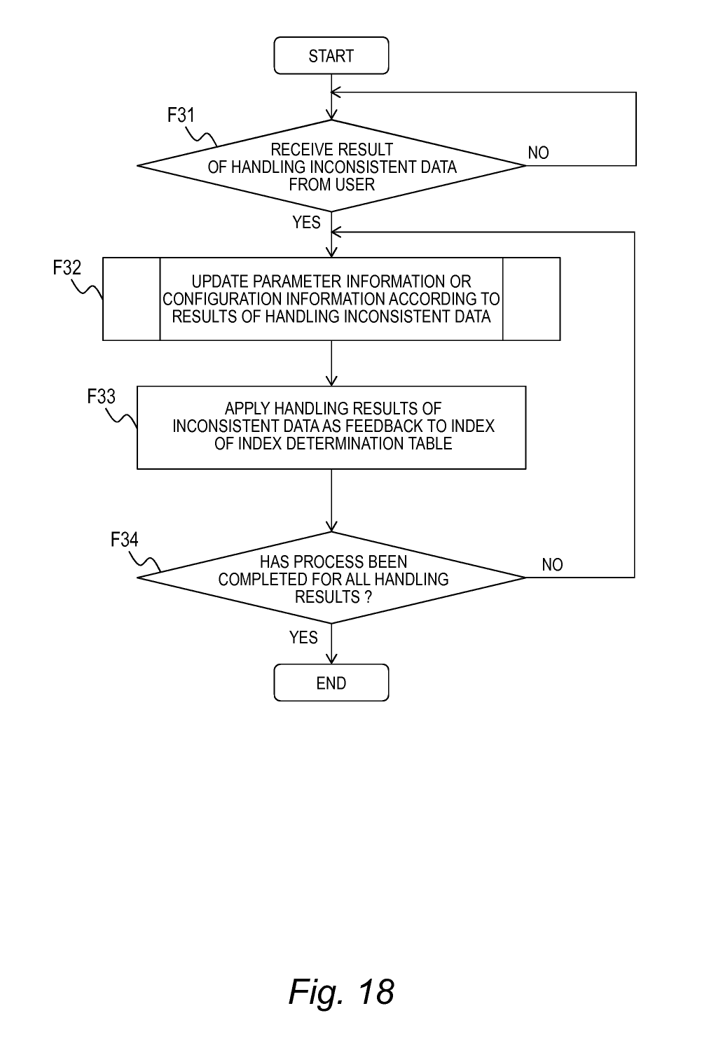

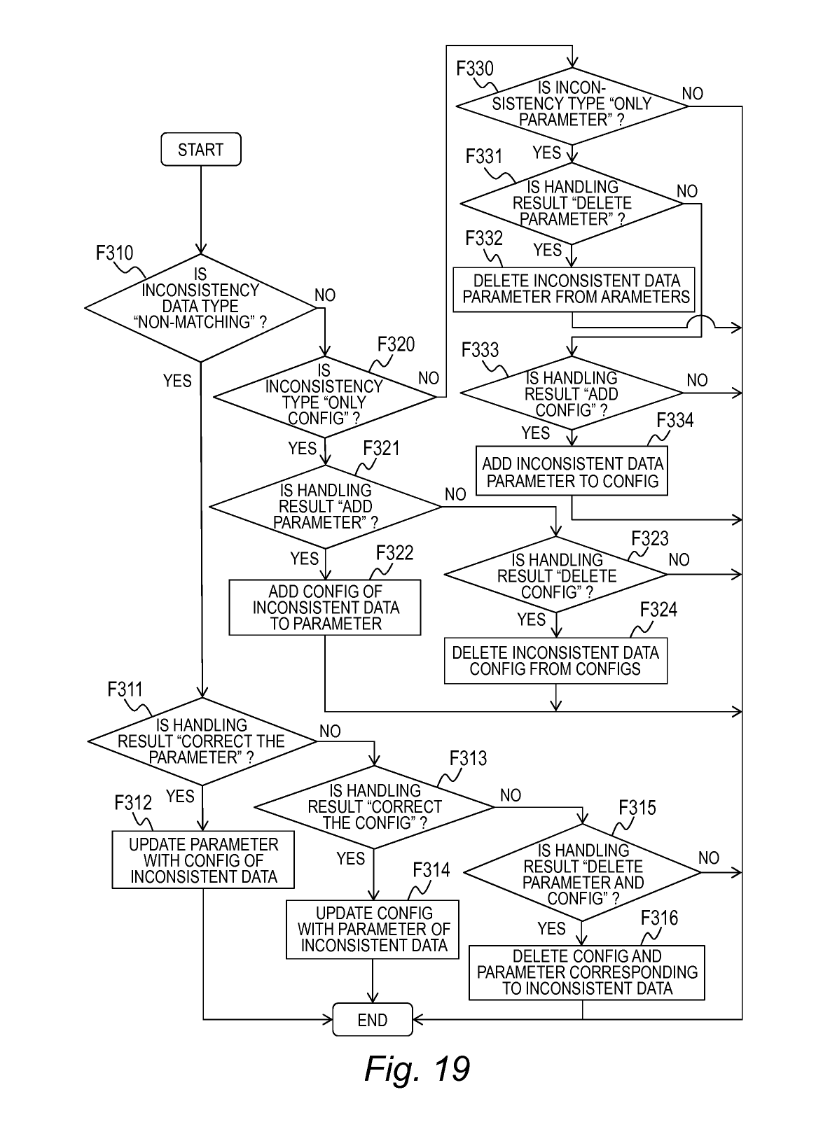

Details of the processes of steps S11 and S12 will be described later with reference to FIGS. 18 and 19.

FIG. 14 is a flowchart showing an example of the process performed in the inconsistent data detection module 209.

In step F11, the network management apparatus 2 determines the next step according to whether or not a trigger to start detection of inconsistent data has been received. If the network management apparatus 2 has receives the detection start trigger, it then progresses to step F12. If the detection start trigger has not been received, then the network management apparatus 2 remains on standby. The detection start trigger is the inconsistent data detection request from the access apparatus 1 shown in FIG. 13, for example.

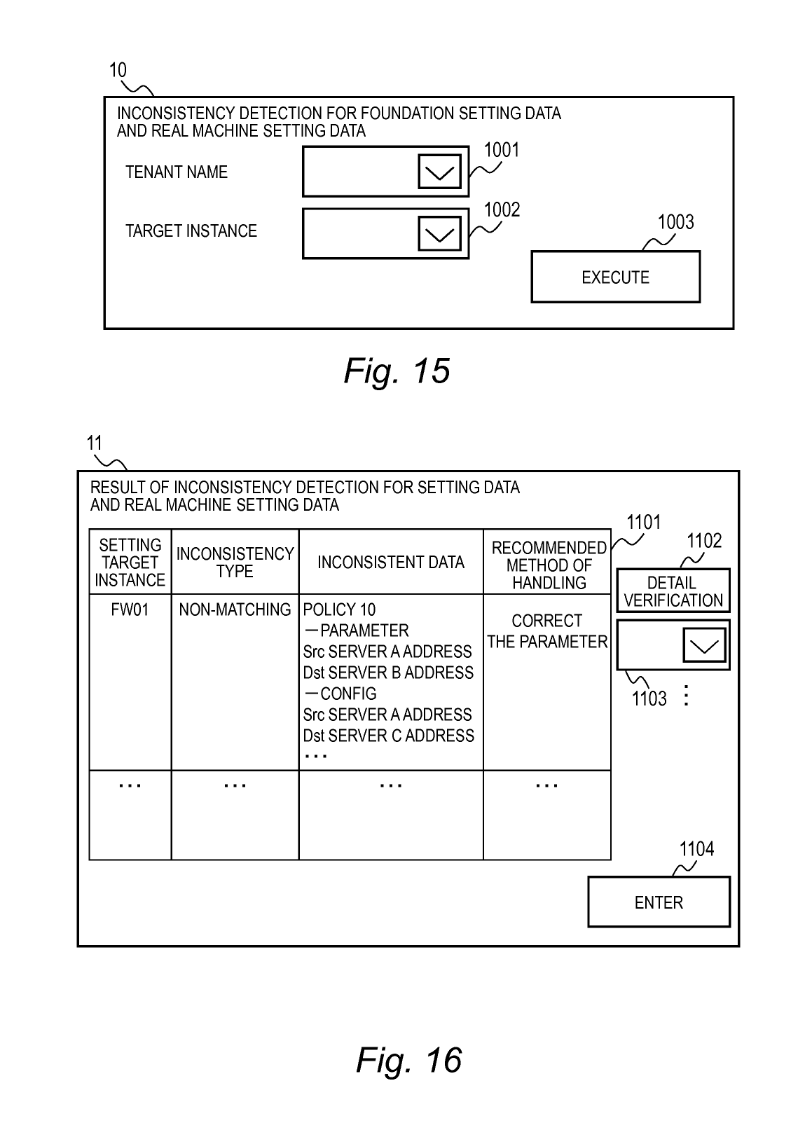

As a method for receiving the detection start trigger, the inconsistent data detection module 309 may have an interface such as a CLI, GUI, or API, with the interface receiving input from the access apparatus 1. An example of an operating screen as an example of the GUI will be described later with reference to FIG. 15.

The request to the network management apparatus 2 includes identifiers of instances for which inconsistent data is to be detected (hereinafter, the instance to be detected). A detection execution request from a device other than the access apparatus 1 may be the trigger.

Besides a request sent from another device to the interface, the MB 3 may have a function of notifying the network management apparatus 2 of a modification event on the configuration information 114, for example, with the MB 3 notifying the network management apparatus 2 that there was a setting modification request on the configuration information 114 from a device other than the network management apparatus 2, and the reception of the notification serving as the detection start trigger.

A request from a device other than the network management apparatus 2 need not necessarily be the start trigger, and the network management apparatus 2 may periodically back up the configuration information 114 of the MBs 3 and start the process to detect the inconsistent data once backup has been completed.

The network management apparatus 2 obtains the modified log data 113 of the configuration information 114 of the MBs 3. The network management apparatus 2 may compare log data of modifications of configuration information 114 of the MB 3 through the interface of the network management apparatus 2 with the obtained log data 113, with the detection of modifications of the configuration information 114 not made through the network management apparatus 2 being the trigger to start detection of inconsistent data.

Detection of modifications of configuration information 114 of the MB 3 not made through the network management apparatus 2 will be explained in detail.

Below, the devices from which the log data 113 is to be obtained are the MB device 3-a=instance FW01, with the device type being an FW made by company A. First, the log data 113 is obtained from the instance FW01. A specific example of log data 113 obtained in this case is described below.

Example of Event Log

YYYY/MM/dd/HH/mm/SS, user B-add, policy ID “10”, Src “server a address”, Dst “server c address”, action “Permit”

YYYY/MM/dd/HH/mm/SS, user A . . .

The log data for modifications of the configuration information 114 of the MB 3 performed through the interface of the network management apparatus 2 is as described below.

Example of Modified Log Data of Configuration information 114 of MB 3 of Network management apparatus 2

YYYY/MM/dd/HH/mm/SS, user A, FW01, API AddPolicy, policy ID “9”, “source address “server a address”, destination address “server b address”, action “Permit”

YYYY/MM/dd/HH/mm/SS, user C, FW01, CLI . . .

At this time, the log data of the network management apparatus 2 is searched with a policy ID “10” of the event log as the key, for example, and if there are no corresponding policy IDs, then it can be determined that the policy of the policy ID “10” has not been set through the network management apparatus 2.

It is also possible to determine that the policy has not been set through the network management apparatus 2 by performing a search with the user ID as the key. If the network management apparatus 2 designates a user A to be the user of the FW01, then it can be determined that setting modifications by other users have not been made through an interface of the network management apparatus 2.

Detection of setting modifications of configuration information 114 of the MB 3 not made through the network management apparatus 2 may be executed at prescribed intervals such as 30 minutes or 1 hour, and the range of log data to be compared may be from the date of the latest modification to a prescribed time in the past. In this manner, it is possible to prevent redundant detection of setting modifications of the configuration information 114, for which detection had been performed in the past.

Next, step F12 of FIG. 14 is a process in which the network management apparatus 2 obtains a parameter of an instance to be detected and the configuration information 114. If completion of backup of the configuration information 114 is set as the detection start trigger, then the configuration information 114 has already been obtained, and thus, in this case, it is possible not to obtain the configuration information 114.

The parameter is obtained by the network management apparatus 2 from the parameter table T1b thereof. The network management apparatus 2 obtains the identifier of the instance to be detected from the detection start trigger received in step F11, and a search is performed on the parameter table T1b with this identifier as the key.

Below, a process of the network management apparatus 2 detecting inconsistent data will be described in detail for an instance in which the identifier is FW01.

In order for the network management apparatus 2 to obtain the parameter of the instance to be detected, the network management apparatus 2 performs a search on the parameter table T1b-a of the setting target instance field 511 (FIG. 5) with the instance identifier FW01 being the search key, and obtains all information of a field in the same row as the setting target instance having a matching key.

In this manner, the network management apparatus 2 can obtain the setting target instance (FW01) 511, the policy ID (1) 512, the source address (server a address) 513, the destination address (server b address) 514, and the action (Permit) 515.

The configuration information 114 can be obtained by the network management apparatus 2 issuing a request of transmission of the configuration information 114 to the instance to be detected and receiving the configuration information 114. The network management apparatus 2 may request the configuration information 114 through a CLI or API of the MB 3, for example.

If the reception of the detection start trigger is not a necessary condition, then detection of inconsistent data may be started upon completion of periodic obtaining of the configuration information 114, for example. In such a case in which the detection start trigger is not received, then the detection target instance may be specified from the configuration information 114.

As a method to do so, the network management apparatus 2 may search for information in which the identifier of the instance and the IP address are associated with the IP address key of the obtained instance. In the present embodiment, it is assumed that the network management apparatus 2 has had the associated information of the identifier and the IP address as of the provisioning of the MBs 3.

In step F13, the network management apparatus 2 detects inconsistent data and identifies the inconsistent data type by comparing the parameter information to be detected and the configuration information 114.

The network management apparatus 2 first converts the configuration information 114 to the structure of the parameter table T1b and sets this as configuration conversion information. The network management apparatus 2 compares the configuration conversion information to the parameter.

In order for the network management apparatus 2 to convert the configuration information 114 to the structure of the parameter table T1b, the configuration and parameter conversion table (conversion information) T4 is used. The following example assumes that the configuration structure obtained from the FW made by company A has the following command columns as shown in FIG. 10.

Example of Configuration Structure of FW Made by Company A
Policy “1”
Src “server a address”
Dst “server c address”
Action “Permit”
. . .

The network management apparatus 2 performs a search on the configuration and parameter conversion table T4 with the company A FW and respective command columns as keys, and converts the corresponding parameters as follows: Policy ″″ to the policy ID; Src ″″ to the source address; Dst ″″ to destination address; and Action ″″ to an action, so as to follow the following parameter structure.

Example of Configuration Structure of Company A FW Converted to Parameter Structure

Policy ID “1”

Source Address “server a address”

Destination Address “server c address”

Action “Permit”

. . .

Next, the network management apparatus 2 compares the configuration information converted to the parameter structure to the parameter table T1b-a. The parameter items to serve as keys for this comparison may be prerecorded in the network management apparatus 2. Only the policy ID; both the source address and the destination address; or all three of the policy ID, source address, and destination address may serve as keys, for example. Below, an example will be described in which the policy ID serves as the key.

First, the network management apparatus 2 compares the key of the configuration conversion information (policy ID) to the parameter key (policy ID), determines whether or not there is a matching ID, and if there is a matching policy ID, the network management apparatus 2 compares other items.

In Embodiment 1, the destination address fields differ between the configuration conversion information and the parameter table T1b-a (FIG. 5).

If the values of the configuration conversion information and parameter do not match in this manner, the network management apparatus 2 determines that the series of configuration information 114 associated with the policy ID and the parameters contain inconsistent data, and the type of inconsistency is determined to be a mismatch of values.

On the other hand, if there is a policy ID that only exists in the converted configuration information 114, then the network management apparatus 2 determines that the series of converted configuration items associated with the ID include inconsistent data with the type of inconsistency being only the configuration information 114.

Also, if there is a policy ID that only exists in the parameters, the network management apparatus 2 determines that the series of parameter items associated with the ID include inconsistent data, and that the type of inconsistency being only the parameter.

In step F14, the network management apparatus 2 determines whether or not the inconsistent data was detected in step F13. If the network management apparatus 2 detects inconsistent data it executes step F15. On the other hand, if the network management apparatus 2 does not detect inconsistent data it ends the process without doing anything.

In step F15, the network management apparatus 2 stores the inconsistent data detected in step F13 and the inconsistent data type to the inconsistent data table T2. The network management apparatus 2 stores the identifier of the detected instance to the setting target instance field 811, stores the inconsistent data in the inconsistent content field 812, and the inconsistent data type in the inconsistency type field 813.

FIG. 15 shows a screen image displayed in the output module of the access apparatus 1 operated when the user issues a request to the network management apparatus 2 for the detection of inconsistent data. The operating screen 10 has a column 1001 in which a tenant name is inputted, a column in which the identifier of the detection target instance is selected, and an execute button 1003 that transmits a detection request packet including the information of 1001 and 1002 to the network management apparatus 2.

A configuration may be adopted in which the column 1001 displays different information depending on the user such that the user can select the names of all tenants if the user is a cloud manager, and if the user is a tenant, then the name of the tenant is already inputted with no other choice, for example.

Also, a configuration may be adopted in which, if the user is the cloud manager, then the column 1002 displays all tenant instances as selectable, and if the user is a tenant, then only instances of the tenant can be selected. Additionally, a configuration may be adopted in which one or more target instances are selectable, and an identifier “all” can be selected to signify all instances.

The choices in the columns 1001 and 1002 are provided by the network management apparatus 2 with reference to data indicating the relation between the instance and the tenant. It is assumed that the data indicating the relation between the instance and the tenant has already been generated when provisioning the MBs 3. The tenant names in the column 1001 are organization identifiers in a case in which a computer system is shared by a plurality of organizations, for example.

FIG. 16 is an example of a screen image that displays inconsistent data content and the recommended method for handling the inconsistent data received from the network management apparatus 2 by the access apparatus 1 operated by the user.

A screen 11 has an identifier of an instance in which inconsistent data is detected, an output column 1101 displaying the relation between the content of the inconsistent data and the recommended handling thereof, a detail verification button 1102 that causes a determination method for an index executed on the inconsistent data and execution results thereof to be outputted, a column 1103 in which the user selects how to handle the inconsistent data, and a decision button 1104 that transmits the selected handling method to the network management apparatus 2.

The content of the output column 1101 may be generated by the network management apparatus 2 partially extracting fields of the inconsistent data table T2. The information displayed by pressing the detail verification button 1102 may be all data of the inconsistent data table T2 transmitted by the network management apparatus 2, for example.

The handling selection column 1103 displays choices such as add to parameter, correct parameter, delete parameter, add to configuration information 114, correct configuration information 114, and delete configuration information 114, for example.

FIG. 17 shows a flowchart by which the inconsistent data handling determination module 210 of the network management apparatus 2 calculates the index of the inconsistent data and decides the recommended handling method therefor on the basis of the index.

Step F21 is a process that determines the next step depending on whether or not the network management apparatus 2 has received a trigger to start calculation of the index for the inconsistent data. If the trigger is received, then step F22 is executed. The start trigger is a command that the inconsistent data detection module 209 transmits to the inconsistent data handling determination module 210 after detection of inconsistent data, for example. On the other hand, if the start trigger has not been received, then the network management apparatus 2 remains on standby.

In step F22, the network management apparatus 2 calculates the index of inconsistent data. The network management apparatus 2 refers to the index determination table T3 and obtains the determination method field 911 (verification process) to be executed.

In the example of FIG. 9, the real machine log verification and the logic configuration verification are in the determination method field 911. The network management apparatus 2 or another component may have the functions for executing these. In the present embodiment, the network management apparatus 2 has the functions for executing the real machine log verification and the logic configuration verification.

First, real machine verification will be described. Real machine verification is one method of determining whether or not communication control according to inconsistent data has actually occurred. In FIG. 9, the following three steps are executed, for example: identification of the inconsistent data field 914 as the comparison key and the comparison data field 915; verification of comparison data using the comparison key; and determination of the index by comparison of the determination results and determination conditions. These will be described in order below.

Identification of Inconsistent Data as Comparison Key and Comparison Data

In the process of step S8 (F12-F15), the inconsistent data obtained by the network management apparatus 2 is as follows, and the instance machine type is “company A FW”.
Setting Target Instance
   FW01
Inconsistent Content
Parameter
   Policy ID “1”
   Source Address “server a address”
   Destination Address “server b address”
   Action “Permit”
Configuration information 114
   Policy ID
   Source Address “server a address”
   Destination Address “server c address”
   Action “Permit”
Inconsistency Type
   Non-Matching

In order to identify the inconsistent data as the comparison key and the comparison data, the network management apparatus 2 uses as search keys on the index determination table T3 the following: determination method: real machine log verification; machine type: company A FW; and inconsistency type: non-matching. The network management apparatus 2 then obtains the inconsistent data field 914 and the comparison data field 915 as comparison keys from rows in which all keys match.

In this manner, the network management apparatus 2 can obtain the inconsistent data as the comparison key (operation log comparison keys: action, source address, destination address; event log comparison keys: policy ID, source address, destination address, action), and comparison data (operation log: YYYY/MM/dd/HHmm/SS ″″ ″″ ″″, and event log: YYYY/MM/dd/HHmm/SS user add policy ″″ Src ″″ Dst ″″ Action ″″).

Additionally, the network management apparatus 2 obtains the determination condition (matching data exists) and an index (50) from the index determination table T3 in a similar search in order to be used later.

Verification of Comparison Data Using Comparison Key and Calculation of Index

The comparison data field 915 is log data and event data obtained as mentioned above. The network management apparatus 2 obtains the log data 113 from the MB 3. The log data 113 shows operation logs indicating the history of the MBs 3 actually controlling packets, and even logs indicating modification history for the configuration information 114.

Example of Operation Log

YYYY/MM/dd/HH/mm/SS Permit server a address server c address http

YYYY/MM/dd/HH/mm/SS . . .

Example of Event Log

YYYY/MM/dd/HH/mm/SS, user A-add, policy ID “10”, Src “server a address”, Dst “server c address”, action “Permit”

YYYY/MM/dd/HH/mm/SS, user B . . .

The network management apparatus 2 then performs a comparison on the obtained operation log using the comparison key of the obtained operation log. In this manner, the network management apparatus 2 can determine whether or not the configuration information 114 of the inconsistent data exists in an event log or operation log. In the example of the operation log, the network management apparatus 2 can determine that the configuration information 114 of the inconsistent data exists.

The network management apparatus 2 then performs a comparison on the event log using the obtained comparison key of the event log. In this manner, it is possible to identify the user and date/time for which configuration information 114 of inconsistent data has been inserted.

By the comparison of log data, the network management apparatus 2 detects whether there is data that matches the inconsistent data and the log data. As a result of the matching data determination condition being satisfied, the network management apparatus 2 determines that the determination condition field 916 of the index determination table T3 is satisfied. The network management apparatus 2 sets a value 50 of the obtained index as an index of real machine log verification results on the inconsistent data.

Next, logic configuration verification will be described. Logic configuration verification is one method of determining whether or not the inconsistent data is defined in the network topology and in the parameter of another instance.

In the logic configuration verification process, the following four steps are executed, for example: identification of the inconsistent data field 914 as the comparison key and the comparison data field 915; verification of the topology table T1a using the comparison key; verification of the parameter table T1b using the comparison key; and determination of the index by comparison of the determination results and determination conditions. These will be described in order below.

Identification of Inconsistent Data Field 914 as Comparison Key and Comparison Data Field 915

In order to identify the inconsistent data field 914 as the comparison key and the comparison data field 915, the network management apparatus 2 uses as search keys on the index determination table T3 the following: determination method: logic configuration verification; machine type: company A FW; and inconsistency type: non-matching. The network management apparatus 2 then obtains the inconsistent data field 914 and the comparison data field 915 as comparison keys from rows in which all keys match. In this manner, the network management apparatus 2 can obtain the inconsistent data field 914 as the comparison key below, and the comparison data field 915.

Comparison key: source address

Comparison target: instance address field of first column of topology table

Comparison key: destination address

Comparison target: instance address field of last column of topology table

Comparison key: destination address

Comparison target: RT parameter table destination address field

Comparison key: destination address

Comparison target: LB parameter table balancing address field

Additionally the network management apparatus 2 obtains by a similar search the determination condition field 916 (#1 matching data exists, #2 matching data exists, #3 matching data exists, #4 matching data exists, #5 #1+#2+#3+#4) and the index field 917 (20, 20, 20, 20, 100), for later use.

Thereafter, the network management apparatus 2 verifies the tables and fields shown in the comparison data field 915 using the comparison key.

Determine Verification and Index of Topology Table T1a Using Comparison Key

When the network management apparatus 2 searches the instance address field on the first column of the topology table T1a with the source address as the key, it can determine that “server a address” is recorded in the topology table T1a. In order to satisfy “#1 matching data exists” in the determination condition field 916 of the index determination table T3, the network management apparatus 2 determines that the value of the index determination field is 20.

Next, when the network management apparatus 2 searches the instance address field on the last column of the topology table T1a with the destination address as the key, it can determine that “server c address” is recorded in the topology table T1a. In order to satisfy “#2 matching data exists” in the determination condition field 916, the network management apparatus 2 determines that the index is 20.

Determine Verification and Index of Parameter Table T1b Using Comparison Key

The network management apparatus 2 searches the destination address field of the parameter table T1b-b of the router (RT01) with the destination address as the key. In this manner, it is possible to determine that “server c address” is recorded in the destination field of the parameter table T1b-b. In order to satisfy “#3 matching data exists” in the determination condition field 916, the network management apparatus 2 determines that the index is 20.

The network management apparatus 2 searches the balancing address field of the parameter table T1b-c of the load balancer (LB01) with the destination address as the key. In this manner, it is possible for the network management apparatus 2 to determine that “server c address” is recorded in the parameter table T1b-c. In order to satisfy “#4 matching data exists” in the determination condition field 916, the network management apparatus 2 determines that the index is 20.

Additionally, the determination condition field 916 has set therein “#5 #1+#2+#3+#4”, or in other words, whether all of #1 to #4 of the determination condition field 916 shown in FIG. 9 is satisfied. By the above search, the “#5” determination condition field 916 is satisfied, and thus, the network management apparatus 2 determines the index to be 100.

In step F23, the network management apparatus 2 determines the recommended method for handling the inconsistent data. If the total of the indices or a value resulting from a prescribed calculation such as averaging is at or above a preset threshold, for example, then the network management apparatus 2 recommends “add data.” On the other hand, if a value resulting from a prescribed calculation is less than a preset threshold, for example, then the network management apparatus 2 recommends “delete data.”

Here, if a method is employed in which the network management apparatus 2 totals the indices as the prescribed calculation of the indices, then if the threshold is 100, for example, the total of the index field 816 of the inconsistent data table T2 shown in FIG. 8 is 230. Because the total in the index field 816 exceeds the threshold, the network management apparatus 2 sets the recommended handling of inconsistent data as “correct parameter.”

The reason that the network management apparatus 2 selected the recommended handling as “correct parameter” is because the inconsistency type field 813 is “non-matching,” the index calculation method field 814 is executed on the configuration information 114 of the inconsistent data, and the index indicating the likelihood of the configuration information 114 being correct has exceeded the threshold. This type of relation between the threshold and the inconsistent data type field 813 and recommended handling field 817 can be preset.

In step F24, the network management apparatus 2 stores the execution results 815 of steps F22 and F23 and the index field 816 to the inconsistent data table T2. The network management apparatus 2 records the name of the executed index calculation method field 814, the method execution result 815, the index field 816, and the recommended handling field 817 to the corresponding fields of the inconsistent data table T2. The respective recorded data may be converted to a format easily understandable by a user.

In step F25, content of the inconsistent data table T2 recorded by the network management apparatus 2 in step F24 is sent to the access apparatus 1 of the user. The network management apparatus 2 may partially process data of the inconsistent data table T2 so as to match the format of the output column 1101 of the screen 11 shown in FIG. 16. Content of the inconsistent data table T2 may be transmitted without being processed and the access apparatus 1 may process data outputted therefrom.

In step F26, it is determined whether or not the network management apparatus 2 has completed processes for all inconsistent data, and if processes are not completed for all inconsistent data, then the process returns to step F22 and the above process is repeated. On the other hand, if processes for all inconsistent data have been completed, then the flowchart of FIG. 17 is ended.

FIG. 18 is a flowchart in which the inconsistent data handling determination module 210 of the network management apparatus 2 processes inconsistent data corresponding to handling results for the inconsistent data received by the access apparatus 1 of the user, and this is applied as feedback to the index field 917 of the index determination table T3. The respective steps will be explained in order.

Step F31 is a process in which the network management apparatus 2 determines which step to execute next depending on whether or not handling results for the inconsistent data have been received from the access apparatus 1 operated by the user. If handling results for inconsistent data are received, then step F31 is executed, and if not, then the process enters standby.

Step F32 is a process in which the network management apparatus 2 updates the configuration information 114 or the parameter information corresponding to the inconsistent data corresponding to the content of the handling results for the inconsistent data received from the access apparatus 1. Details of this process will be described later with reference to FIG. 19.

In step F33, the network management apparatus 2 applies as feedback to the index field 917 of the index determination table T3 the handling results for the inconsistent data received from the access apparatus 1, according to whether or not the results match the recommended handling method.

If the recommended handling field 817 and the handling method chosen by the user match, for example, then the process adds a value to the index field 917 related to the corresponding determination condition field 916 among the index calculation method fields 814 (911) executed by the network management apparatus 2.

On the other hand, if the recommended handling field 817 and the handling method chosen by the user do not match, for example, then the network management apparatus 2 subtracts a value from the index field 917 related to the corresponding determination condition field 916 among executed the index calculation method fields 814 (911).

The value added to or subtracted from the index field 917 can be a predetermined value, and the network management apparatus 2 may store this information.

In step F34, it is determined whether or not the network management apparatus 2 has completed processes for all handling results determined by the user, and if there are unprocessed handling results, then the process returns to step F32 and the above process is repeated. When the processes are completed for all handling results, then the flowchart of FIG. 18 is ended.

By the above processes, it is possible to apply the execution results of the determination method as feedback to the index field 917 set in the index determination table T3.

FIG. 19 is a flowchart showing one example of an inconsistent data process performed by the inconsistent data handling determination module 210 corresponding to the content of the handling results for the inconsistent data received from the access apparatus 1.

In the process for the inconsistent data corresponding to the content of the handling results for the inconsistent data, the network management apparatus 2 receives handling results for the inconsistent data from the access apparatus 1, obtains the inconsistency type field 813 of the inconsistent data and obtains the handling results received from the access apparatus 1 operated by the user, compares the inconsistency type field 813 to the handling results, and adds, deletes, or corrects inconsistent data to the configuration information 114 or the parameter table T1b on the basis of the comparison results. The inconsistency type field 813 is added to the handling results by the access apparatus 1 and sent as a notification to the network management apparatus 2. The access apparatus 1 may add the setting target instance field 811 and the inconsistent content field 812 to the handling results as a notification to the network management apparatus 2. Alternatively, the access apparatus 1 may send a record number of the inconsistent data table T2 corresponding to the handling results to the network management apparatus 2 as a notification.

When the network management apparatus 2 receives the handling results from the access device 1, then the network management apparatus 2 obtains the inconsistency type field 813 of the inconsistent data and starts the process of FIG. 19.

In step F310, it is determined whether or not the obtained inconsistency type (813) is determined to be “non-matching.” If the inconsistency type is “non-matching,” then the network management apparatus 2 executes step F311, and if the inconsistency type is anything other than “non-matching,” then the network management apparatus 2 executes step F320.

In step F311, the network management apparatus 2 determines whether or not the handling result is “correct the parameter.” If the handling result is “correct the parameter,” then the network management apparatus 2 executes step F312, and if the handling result is not “correct the parameter,” then the network management apparatus 2 executes step F313.

In step F312, the network management apparatus 2 updates the parameter table T1-b detected as inconsistent data with the content of the configuration information 114 detected as the inconsistent data. The parameter information and configuration information 114 detected as inconsistent data can be identified from the setting target instance field 811 and inconsistent content field 812 or the record number received from the access apparatus 1.

By the process above, if the inconsistency type is “non-matching,” and the handling result is “correct the parameter,” then the parameter table T1b of the network management apparatus 2 is corrected to the content of the configuration information 114 detected as the inconsistent data, and the process is ended.

In step F313, the network management apparatus 2 determines whether or not the handling result is “correct the config.” If the handling result is “correct the config,” then the network management apparatus 2 executes step F314, and if the handling result is not “correct the config,” then the network management apparatus 2 executes step F315.

In step F314, the network management apparatus 2 updates the content of the configuration information 114 detected as inconsistent data with the content of the parameter detected as the inconsistent data. The updating of the configuration information 114 of the MBs 3 may use a provisioning function of the network management apparatus 2, for example.

By the process above, if the inconsistency type is “non-matching,” and the handling result is “correct the config,” then the configuration information 114 of the MBs 3 for which inconsistent data was detected (setting target instance) is corrected to the content of the parameter detected as the inconsistent data, and the process is ended.

In step F315, the network management apparatus 2 determines whether or not the handling result is “delete the parameter and config.” If the handling result is “delete the parameter and config,” then the network management apparatus 2 executes step F316, and if the handling result is not “delete the parameter and config,” then the network management apparatus 2 simply ends the process.

In step F316, the network management apparatus 2 deletes the inconsistent data from the parameter table T1b and deletes the inconsistent data from the configuration information 114 of the MBs 3 for which the inconsistent data was detected.

By the process above, if the inconsistency type is “non-matching,” and the handling result is “delete the parameter and config,” then inconsistent data is deleted from the parameter table T1b of the network management apparatus 2 and the configuration information 114 of the MBs 3 for which the inconsistent data was detected, and the process is ended.

In step F320, the network management apparatus 2 determines whether or not the handling result is “only config.” If the inconsistency type is “only config,” then the network management apparatus 2 executes step F321, and if the inconsistency type is not “only config,” then the network management apparatus 2 executes step F330.

In step F321, the network management apparatus 2 determines whether or not the handling result is “add parameter.” If the handling result is “add parameter,” then the network management apparatus 2 executes step F322, and if the handling result is not “add parameter,” then the network management apparatus 2 executes step F323.

In step F322, the network management apparatus 2 adds the configuration information 114 detected as the inconsistent data to the parameter table T1b.

By the process above, if the inconsistency type is “only config,” and the handling result is “add parameter,” then the configuration information 114 of the MBs 3 for which the inconsistent data was detected is added to the parameter table T1b of the network management apparatus 2.

In step F323, the network management apparatus 2 determines whether or not the handling result is “delete config.” If the inconsistency type is “delete config,” then the network management apparatus 2 executes step F324, and if the inconsistency type is not “delete config,” then the network management apparatus 2 simply ends the process.

In step F324, the network management apparatus 2 deletes the configuration information 114 detected as the inconsistent data among the configuration information 114 of the MBs 3 for which inconsistent data was detected.

By the process above, if the inconsistency type is “only config” and the handling result is “delete config,” then the configuration information 114 detected as inconsistent data from the MBs 3 for which the inconsistent data was detected is deleted.

In step F330, the network management apparatus 2 determines whether or not the inconsistency type is “only parameter.” If the inconsistency type is “only parameter,” then the network management apparatus 2 executes step F331, and if the inconsistency type is not “only parameter,” then the network management apparatus 2 simply ends the process.

In step F331, the network management apparatus 2 determines whether or not the handling result is “delete parameter.” If the handling result is “delete the parameter,” then the network management apparatus 2 executes step F332, and if the handling result is not “delete the parameter,” then the network management apparatus 2 executes step F333.

In step F332, the network management apparatus 2 deletes the parameter obtained as the inconsistent data to the parameter table T1b, and ends the process.

By the process above, if the inconsistency type is “only parameter” and the handling result is “delete parameter,” then the parameter detected as the inconsistent data is deleted.

In step F333, the network management apparatus 2 determines whether or not the handling result is “add config.” If the inconsistency type is “add config,” then the network management apparatus 2 executes step F334, and if the inconsistency type is not “add config,” then the network management apparatus 2 simply ends the process.

In step F334, the network management apparatus 2 adds the parameter obtained as inconsistent data to the configuration information 114 of the MBs 3 for which inconsistent data was detected.

By the process above, if the inconsistency type is “only parameter” and the handling result is “add config,” then the parameter detected as inconsistent data is added to the configuration information 114 of the MBs 3 for which the inconsistent data was detected.

In this manner, the access apparatus 1 operated by a user can receive content of detected inconsistent data and recommended methods for handling the inconsistent data, and thus, there is no need for inconsistent data to be detected manually. Furthermore, by referring to the recommended method for handling the inconsistent data, the decision of whether to delete or correct inconsistent data becomes much easier to make.

In the present invention, it is possible to automatically detect inconsistency in the MBs 3 and the parameter table T1b from the parameter information and the configuration information by the inconsistent data detection module 209 of the network management apparatus 2. The inconsistent data handling determination module 210 can calculate an index for evaluating the inconsistent data and output a recommended method for handling the inconsistent data corresponding to this index. In this manner, it is possible to reduce the amount of work required to determine whether or not the parameter information and configuration information found to be inconsistent are indeed inconsistent, and to determine the necessity of the inconsistent data.

In Embodiment 1, an example was described in which inconsistent data is detected by generating config conversion information in which the configuration information 114 of the MBs 3 is converted to a parameter information data format, and comparing the parameter table T1b of the network management apparatus 2 and the config conversion information, but the configuration is not limited thereto.

A configuration may be adopted in which the parameter table T1b of the network management apparatus 2 is converted to the configuration information data format and compared with the configuration information 114 of the MBs 3, for example. Alternatively, the network management apparatus 2 may detect inconsistent data after converting the parameter table T1b and the configuration information 114 respectively to a data format for comparison. If the data for comparison is parameter data, the configuration is that of Embodiment 1, and if the data for comparison is configuration information, then this describes the configuration above. Thus, the data for comparison may be either one of the parameter information and the configuration information.

In Embodiment 1, an example was described in which the network management apparatus 2 determines the recommended method of handling the inconsistent data on the basis of the index, but a configuration may be adopted in which the recommended method of handling corresponding to the inconsistency type field 813 is set in advance and the index and recommended method of handling are both transmitted to the access apparatus 1.

### Embodiment 2

Next, Embodiment 2 will be described. Embodiment 2 is effective for a case in which a network management apparatus 2 is being newly introduced to an already operating computer system, or when transferring the network management apparatus 2 from an operating computer system to another system.

In Embodiment 2, the configuration of the computer system to which the network management apparatus 2 is newly introduced or to which the network management apparatus 2 is being transferred is similar to that of Embodiment 1. This applies not only to the configuration of the computer system but also to the devices comprising the computer system. In other words, the configuration of the respective devices, the table configuration, and processes are similar to those of Embodiment 1 with the exception of a portion of the process of the inconsistent data handling determination module 210 (FIG. 17 flowchart).

The characteristic of Embodiment 2 is that when the network management apparatus 2 is being newly introduced, all inconsistent data types are “only configuration information 114,” and when the network management apparatus 2 is being transferred to another system, all inconsistent data types are “only parameter.” In Embodiment 2, in order to handle the above situation, more functionality is added to the inconsistent data handling determination module 210 and a process differing in part from the flowchart of FIG. 17 is performed.

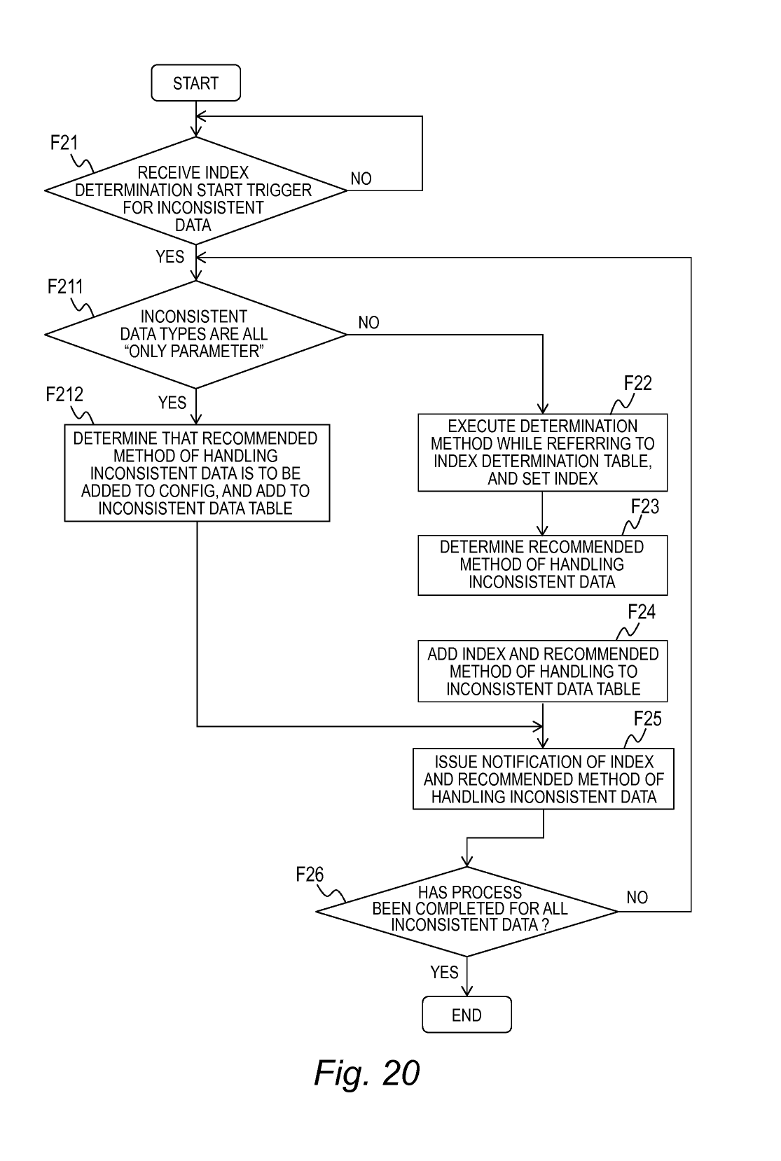

FIG. 20 is a flowchart showing an example of a process performed by the inconsistent data handling determination module 210 for handling the new introduction of the network management apparatus 2 or the transfer thereof to another computer system. FIG. 20 shows a flowchart by which the inconsistent data handling determination module 210 calculates the index of the inconsistent data and determines the recommended method for handling thereof. The respective steps will be explained in order. In the drawing, steps F21, F22, F23, F24, and F25 are similar to Embodiment 1, and thus, redundant descriptions thereof will be omitted.

In step F211, the network management apparatus 2 determines whether or not all inconsistency types for inconsistent data are “only parameter.” If all the inconsistency types are “only parameter,” then the network management apparatus 2 progresses to step F212, and if not all inconsistency types are “only parameter,” then the network management apparatus 2 progresses to step F22. The process after step F22 is similar to that of Embodiment 1.

Whether or not the inconsistency types for the inconsistent data are all “only parameter” can be determined by the network management apparatus 2 by referring to all inconsistency type fields 813 of the inconsistent data table T2.

If the network management apparatus 2 is being newly introduced, or in other words, if the inconsistent data types are all “only configuration information 114,” then the process does not differ from that of Embodiment 1.

In step F212, the network management apparatus 2 determines simultaneously for all inconsistent data that the recommended method for handling thereof is “add config,” and this result is recorded in the recommended handling field 817 of the inconsistent data table T2. There is no particular need to distinguish the index field 816 of inconsistent data.

Also, a configuration may be adopted such that when sending the recommended handling field 817 for the inconsistent data to the access apparatus 1 or the like, if all inconsistent data types are “only config” or “only parameter,” the screen 11 display results as shown in FIG. 16 of Embodiment 1 outputs whether the network management apparatus 2 has been newly introduced or transferred to another computer system, allowing the user of the access apparatus 1 to confirm.

In this manner, in Embodiment 2, when the network management apparatus 2 is transferred to another computer system, the parameter table (T1b) prior to transfer is reflected in the configuration information 114 of the MBs 3. When the network management computer 2 is being newly introduced, the index has been determined for all configuration information 114, and thus, the determination for configuration information 114 to be recorded in the parameter table T1b becomes easy.

As described above, according to Embodiment 2, it is possible to ensure consistency in the parameter table T1b or the configuration information 114 when newly introducing the network management apparatus 2 to an already operating computer system, or when transferring the network management apparatus 2 from an operating computer system to another system.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD. The control lines and information lines described are lines that are deemed necessary for the description of this invention, and not all of control lines and information lines of a product are mentioned. In actuality, it can be considered that almost all components are coupled to one another.

What is claimed is:

1. A management apparatus that manages a network apparatus including a packet control function,
wherein the network apparatus has configuration information that sets the control function, and
wherein the management apparatus has:
parameter information that manages settings of the control function of the network apparatus; and
an inconsistent data detection module that obtains the configuration information from the network apparatus, and upon comparison of the configuration information with the parameter information, detects, as inconsistent data, information that does not match.

2. The management apparatus according to claim 1, further comprising:
an inconsistent data handling module that calculates an index indicating that the presence of the inconsistent data is correct, determines a recommended method for handling the inconsistent data on the basis of the index, and outputs the inconsistent data, the index, and the recommended method for handling the inconsistent data.

3. The management apparatus according to claim 2,
wherein the inconsistent data handling module receives an inconsistent data handling result and updates the configuration information and the parameter information corresponding to the handling result.

4. The management apparatus according to claim 1,
wherein the inconsistent data detection module performs the comparison after converting the configuration information and the parameter information to the same data format, and detects, as inconsistent data, non-matching data.

5. The management apparatus according to claim 4,
wherein the inconsistent data detection module determines whether a type of the inconsistent data is one of the following: inconsistency in only the configuration information; inconsistency in only the parameter information; and inconsistency in both the configuration information and the parameter information.

6. The management apparatus according to claim 2,
wherein the inconsistent data handling module executes a pre-set verification process, and if a result of executing the verification process satisfies a pre-set determination condition, then a value pre-set for the determination condition is set as a value of the index, the inconsistent data handling module determining the recommended method for handling the inconsistent data on the basis of the index.

7. The management apparatus according to claim 6,
wherein the inconsistent data detection module determines whether a type of the inconsistent data is one of the following: inconsistency in only the configuration information; inconsistency in only the parameter information; and inconsistency in both the configuration information and the parameter information, and
wherein the inconsistent data handling module receives the handling result for the inconsistent data, updates the configuration information and the parameter information corresponding to the handling result and the type of the inconsistent data, and updates the index corresponding to the handling result.

8. The management apparatus according to claim 6,
wherein the network apparatus stores logs corresponding to execution of processes, and
wherein the inconsistent data handling module includes, as the verification processes, a first verification process of verifying the inconsistent data against the logs of the network apparatus and a second verification process of verifying the inconsistent data against connection configuration information of the network apparatus and the parameter information.

9. The management apparatus according to claim 3,
wherein the inconsistent data detection module determines whether a type of the inconsistent data is one of the following: inconsistency in only the configuration information; inconsistency in only the parameter information; and inconsistency in both the configuration information and the parameter information, and
wherein, if the type of the inconsistent data is inconsistency in both the configuration information and the parameter information, the inconsistent data handling module updates the parameter information with the configuration information determined to be the inconsistent data if the handling result is to correct the parameter information, updates the configuration information with the parameter information if the handling result is to correct the configuration information, and deletes the configuration information and the parameter information determined as the inconsistent data if the handling result is to delete the configuration information and the parameter information,
wherein, if the type of the inconsistent data is inconsistency in only the configuration information, the inconsistent data handling module adds the configuration information determined to be the inconsistent data to the parameter information if the handling result is to add to the parameter information, and deletes the configuration information determined to be the inconsistent data if the handling result is to delete the configuration information, and
wherein, if the type of the inconsistent data is inconsistency in only the parameter information, the inconsistent data handling module deletes the parameter information determined to be the inconsistent data if the handling result is to delete the parameter information, and adds the parameter information to the configuration information if the handling result is to add to the configuration information.

10. A method of managing a network apparatus including a packet control function using a management apparatus having a processor and memory, the method comprising:
a first step in which the management apparatus obtains configuration information that sets the control function of the network apparatus; and
a second step in which the management apparatus performs comparison between the configuration information and parameter information that manages settings of the control function of the network apparatus, and detects, as inconsistent data, information that does not match according to the comparison.

11. The method of managing a network apparatus according to claim 10, further comprising:
a third step in which the management apparatus calculates an index indicating that the presence of the inconsistent data is correct, determines a recommended method for handling the inconsistent data on the basis of the index, and outputs the inconsistent data, the index, and the recommended method for handling the inconsistent data.

12. The method of managing a network apparatus according to claim 11, further comprising:
a fourth step in which the management apparatus receives an inconsistent data handling result and updates the configuration information and the parameter information corresponding to the handling result.

13. The method of managing a network apparatus according to claim 10,
wherein, in the second step, the comparison is performed after converting the configuration information and the parameter information to the same data format, and non-matching data is detected as inconsistent data.

14. A computer-readable non-transitory data storage medium, containing a program for controlling a computer including a processor and memory,
wherein the program causes the computer to execute:
a first step of obtaining configuration information that sets a control function of a network apparatus; and
a second step of performing comparison between the configuration information and parameter information that manages settings of the control function of the network apparatus coupled to the computer, and detects, as inconsistent data, information that does not match according to the comparison.

15. The storage medium according to claim 14, further comprising:
a third step in which an index indicating that the presence of the inconsistent data is correct is calculated, a recommended method for handling the inconsistent data is determined on the basis of the index, and the inconsistent data, the index, and the recommended method for handling the inconsistent data are outputted.
